(19) United States
(12) Patent Application Publication
(10) Pub. No.: US 2014/0250214 A1
(43) Pub. Date: Sep. 4, 2014

(54) COMPUTER SYSTEM, PROGRAM-COOPERATIVE METHOD, AND PROGRAM

(71) Applicants: Yoji Onishi, Tokyo (JP); Yoshifumi Takamoto, Tokyo (JP)

(72) Inventors: Yoji Onishi, Tokyo (JP); Yoshifumi Takamoto, Tokyo (JP)

(73) Assignee: HITACHI, LTD., Tokyo (JP)

(21) Appl. No.: 14/352,622

(22) PCT Filed: Nov. 25, 2011
(86) PCT No.: PCT/JP2011/077177

§ 371 Date: Apr. 17, 2014

(51) Int. Cl. H04L 12/24

(52) U.S. Cl. CPC H04L 41/0803
USPC 709/220

(57) ABSTRACT

A computer system comprises at least one computer having at least one input-output interface that is connectable to at least one external device, at least one storage apparatus having at least one storage area, and a management computer having a computer management part and a storage management part. The computer management part includes a configuration information acquisition part, an allocation control part, and a storage management cooperation part. The allocation control part outputs, as at least one allocation candidate, at least one input-output interface connected to the at least one storage apparatus among the at least one input-output interface of a new computer, and receives at least one input-output interface selected by a user. The storage management part makes it possible to access, from the at least one input-output interface of which the storage management part is notified, the at least one storage area.

### BACKGROUND OF THE INVENTION

The present invention relates to computer systems that manage computers and storage apparatuses and, in particular, to a computer system that shares information between a program which manages a computer and a program which manages a storage apparatus.

A management computer exists which manages a physical server (computer) and a storage apparatus that provides the physical server with a storage area (LU (Logical Unit)).

On the management computer, server management software that manages the physical server and storage management software that manages the storage apparatus operate. The server management software retains information concerning the physical server, and the storage management software retains information concerning the storage apparatus.

A process for newly allocating a storage area to the physical server is executed by the storage management software, but the storage management software does not retain the information concerning the physical server.

It should be noted that in causing the storage management software to execute the process for allocating a storage area, an administrator needs to input to the storage management software the address (WWN or MAC address) of an input-output interface of which physical server that is connected to the storage apparatus.

For this reason, the administrator needs to grasp the information concerning the physical server (i.e. the address of an input-output interface of the physical server that is connected to the storage apparatus).

If the administrator is authorized to operate the storage management software and the server management software, the administrator will grasp the information concerning the physical server by operating the server management software; however, to do so, the administrator must have a good knowledge of how to use the server management software, and is required to be highly skilled.

Further, in a case where the storage management software and the server management software are managed by different administrators, the administrator of the storage management software must share the information concerning the physical server in a memo with the administrator of the server management software. This may cause incorrect configuration.

Due to such incapability of sharing information between the server management software and the storage management software, there has been a decrease in management efficiency.

In a data center or the like, there is a further decrease in management efficiency due to an increase in both the number of storage apparatuses and the number of physical servers.

A management computer is known which configures, on the basis of a relationship of connection between a port of a storage apparatus and an I/O (Input/Output) adaptor of a physical server, a path between an LU in the storage apparatus and a virtual computer that operates on the physical server (for example, see Japanese Patent Laid-Open No. 2010-257274).

### SUMMARY OF THE INVENTION

The management computer disclosed in JP 2010-257274 is not based on the premise that server management software and storage management software operate. For this reason, JP 2010-257274 does not disclose sharing information between server management software and storage management software. Therefore, even the management computer disclosed in Japanese Patent Laid-Open No. 2010-257274 A suffers from a decrease in management efficiency with which a storage area in a storage apparatus is allocated to a physical server.

It is an object of the present invention to provide a computer system that improves management efficiency with which a storage area in a storage apparatus is allocated to a physical server.

A representative example of an invention that is disclosed in the present application is as follows: a computer system comprising: at least one computer having at least one input-output interface that is connectable to at least one external device; at least one storage apparatus having at least one storage area that is allocatable to the at least one computer coupled thereto via the at least one input-output interface; and a management computer having a computer management part that manages the at least one computer and a storage management part that manages the at least one storage apparatus, the management computer holding connection management information for managing at least one relationship of connection between the at least one computer and the at least one storage apparatus, the computer management part including: a configuration information acquisition part that acquires configuration information including an identifier of a new computer and at least one identifier of the at least one input-output interface of the new computer; in a case where the new computer is added to the computer system, an allocation control part that, based on the configuration information acquired by the configuration information acquisition part and the connection management information, outputs as at least one allocation candidate, the at least one input-output interface connected to the at least one storage apparatus among the at least one input-output interface of the new computer, and that receives at least one input-output interface selected by a user among the at least one outputted allocation candidate; and a storage management cooperation part that notifies the storage management part of the identifier of the new computer and at least one identifier of the at least one input-output interface received by the allocation control part, and that invokes the storage management part, the storage management part is configured to; hold the identifier of the new computer and the at least one of the identifier of the at least one of input-output interface of which the storage management part is notified, allocate the at least one storage area to the new computer, by making it possible to access, from the at least one input-output interface identified by the at least one identifier of the at least one of the input-output interface of which the storage management part is notified, the at least one storage area of the at least one storage apparatus connected to the at least one input-output interface. This invention enables to provide the computer system that improves management efficiency with which a storage area in a storage apparatus is allocated to a physical server.

### BRIEF DESCRIPTION OF THE DRAWINGS

FIG. 1 is an explanatory diagram of a configuration of a computer system according to a first embodiment of the present invention.

FIG. 2 is an explanatory diagram of a storage apparatus according to the first embodiment of the present invention.

FIG. 3 is an explanatory diagram of a server management part and a storage management part of a management server according to the first embodiment of the present invention.

FIG. 4 is an explanatory diagram of cooperation between the server management part and the storage management part according to the first embodiment of the present invention.

FIG. 5 is a hardware configuration diagram of the management server according to the first embodiment of the present invention.

FIG. 6 is a hardware configuration diagram of a physical server according to the first embodiment of the present invention.

FIG. 7 is an explanatory diagram of a server management table according to the first embodiment of the present invention.

FIG. 8 is an explanatory diagram of a storage management table according to the first embodiment of the present invention.

FIG. 9 is an explanatory diagram of a connection management table according to the first embodiment of the present invention.

FIG. 10 is an explanatory diagram of a boot device management table according to the first embodiment of the present invention.

FIG. 11 is an explanatory diagram of a server configuration information acquisition agent management table according to the first embodiment of the present invention.

FIG. 12 is an explanatory diagram of a nickname management table according to the first embodiment of the present invention.

FIG. 13 is a flow chart of a server management process according to the first embodiment of the present invention.

FIG. 14 is a flow chart of a server information acquisition process according to the first embodiment of the present invention.

FIG. 15 is a flow chart of a process that is executed by a server configuration information acquisition agent according to the first embodiment of the present invention.

FIG. 16 is a flow chart of a disk allocation control process according to the first embodiment of the present invention.

FIG. 17 is a flow chart of a disk protocol selection process according to the first embodiment of the present invention.

FIG. 18 is an explanatory diagram of a server management screen according to the first embodiment of the present invention.

FIG. 19 is a flow chart of a storage management cooperation process according to the first embodiment of the present invention.

FIG. 20 is a flow chart of a storage management process according to the first embodiment of the present invention.

FIG. 21 is an explanatory diagram of a storage management screen according to the first embodiment of the present invention.

FIG. 22 is a flow chart of a process that is executed by a server configuration information acquisition agent according to a second embodiment of the present invention.

FIG. 23 is an explanatory diagram of a configuration of a computer system according to a third embodiment of the present invention.

FIG. 24 is a flow chart of the server management process according to the third embodiment of the present invention.

### DESCRIPTION OF EMBODIMENTS

Embodiments for carrying out the present invention are described below with reference to the drawings. For clarification of explanation, the following descriptions and the drawings are appropriately subject to omissions and simplifications. Further, in each of the drawings, the same elements are given the same reference numerals, and for clarification of explanation, repeated explanations are omitted as needed.

### First Embodiment

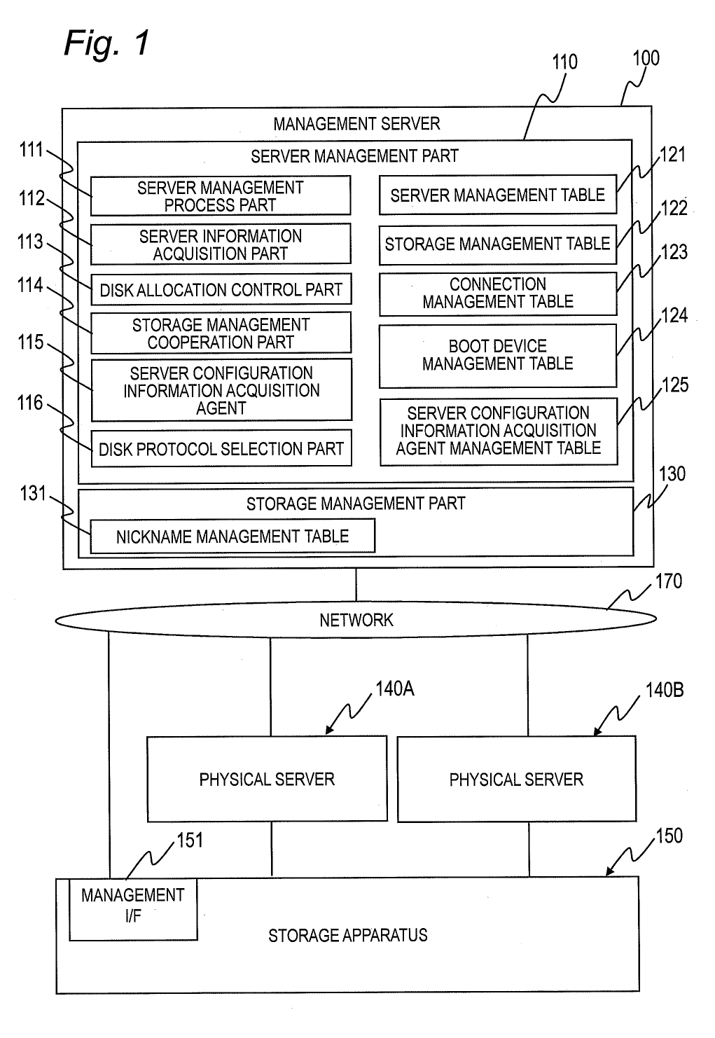

A first embodiment of the present invention is described below with reference to FIGS. 1 through 21.

FIG. 1 is an explanatory diagram of a configuration of a computer system according to the first embodiment of the present invention.

The computer system of the present embodiment includes a management server 100, physical servers (computers) 140A and 140B, and a storage apparatus 150. The physical servers 140A and 140B are hereinafter collectively referred to as “physical servers 140”.

The management server 100 is connected to the physical servers 140 and the storage apparatus 150 via a network 170. Each of the physical servers 140 is connected to the storage apparatus 150 via a network (for example, a fiber channel; not illustrated).

The management server 100 is a computer that manages the physical servers 140 and the storage apparatus 150, and includes a server management part (computer management part) 110 that manages the physical servers 140 and a storage management part 130 that manages the storage apparatus 150.

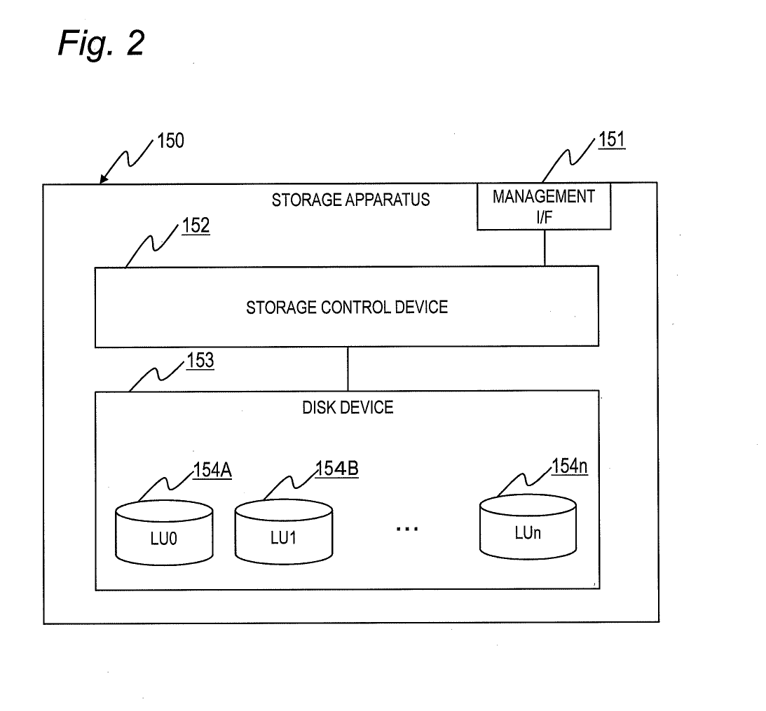

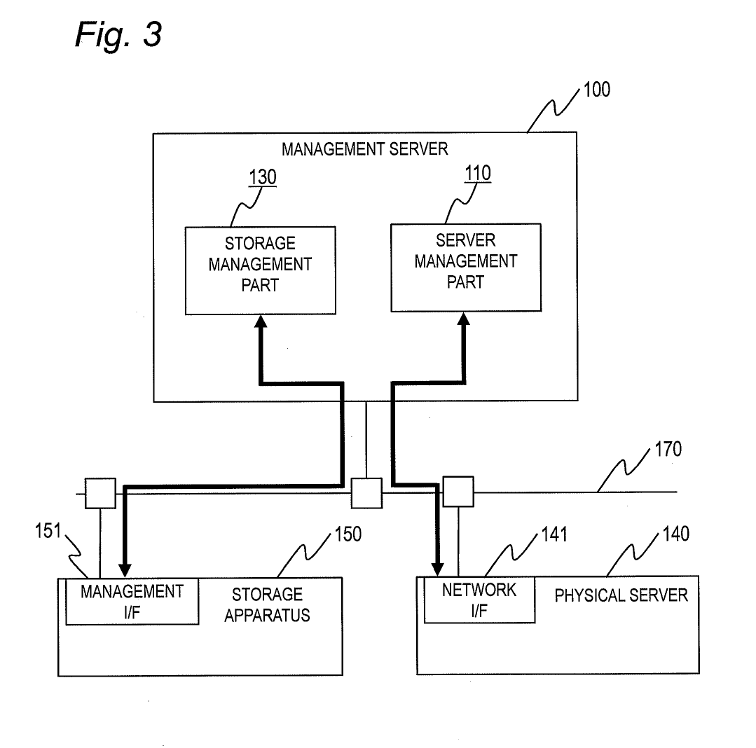

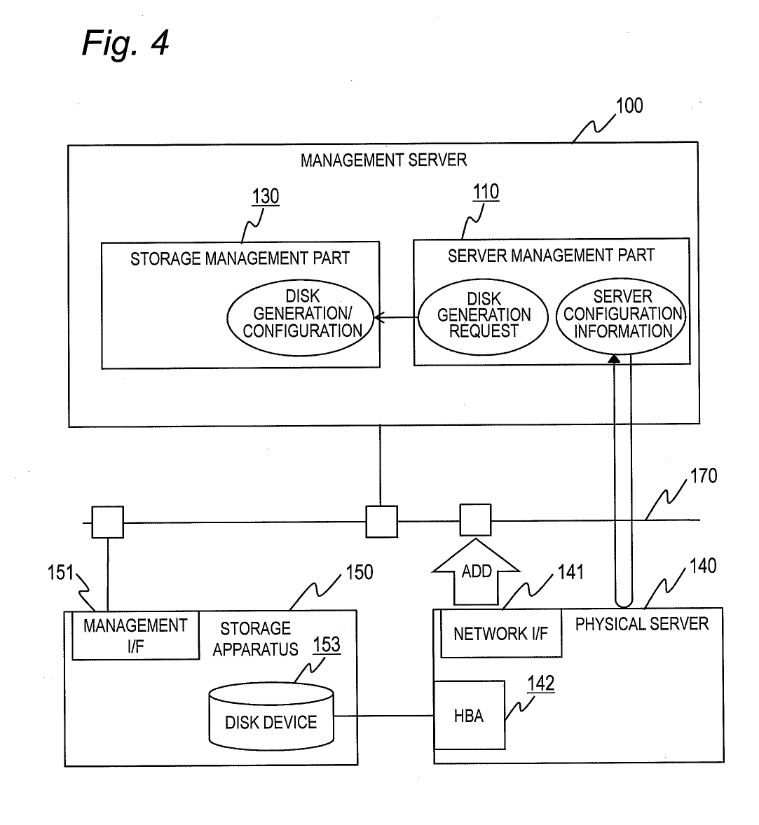

Each of the physical servers 140 can access a logical volume (LU) 154 (see FIG. 2), i.e. a storage area in the storage apparatus 150 which is allocated thereto, and reads and writes data from and to the storage area. Further, each of the physical servers 140 is connected to the network 170 via a network interface 141 (see FIGS. 3 and 4).

As mentioned above, the storage apparatus 150 writes data from the physical servers 140 to a storage area. Further, the storage apparatus 150 is connected to the network 170 via a management interface (I/F) 151.

The management server 100 is described in detail here.

As mentioned above, the management server 100 includes the server management part 110 and the storage management part 130.

The server management part 110 includes a server management process part 111, a server information acquisition part 112, a disk allocation control part 113, a storage management cooperation part 114, a server configuration information acquisition agent 115, a disk protocol selection part 116, a server management table 121, a storage management table 122, a connection management table 123, a boot device management table 124, and a server configuration information acquisition agent management table 125.

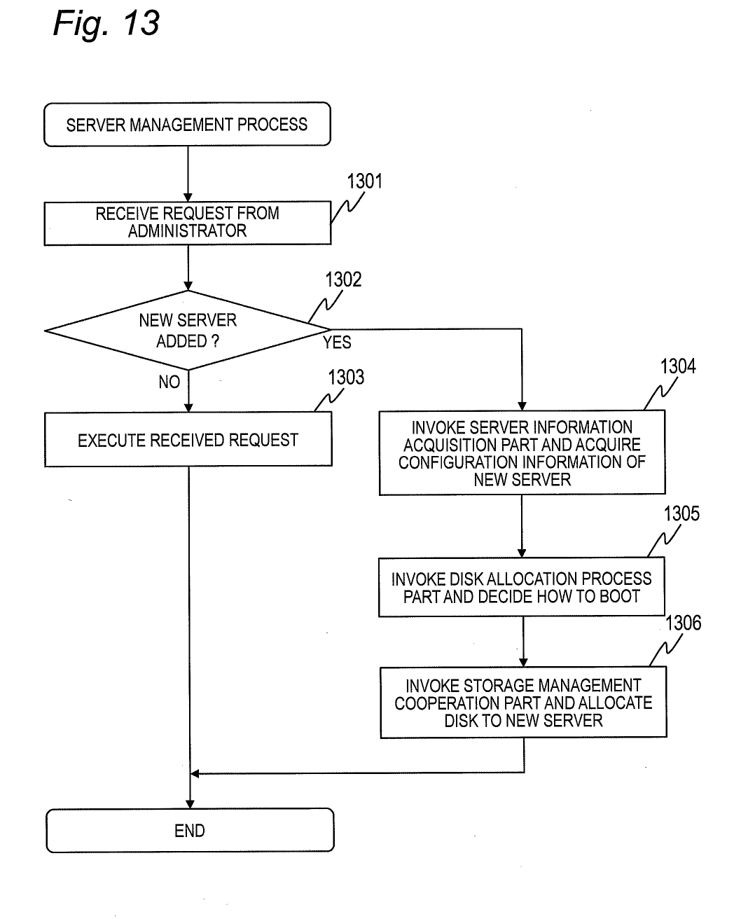

The server management process part 111 executes various types of process in accordance with a request from an administrator. Of the various types of process that are executed by the server management process part 111, a process for adding a new physical server 140 (hereinafter referred to as “new server”) to the computer system is described in detail in the present embodiment. A process that is executed by the server management process part 111 will be described in detail with reference to FIG. 13.

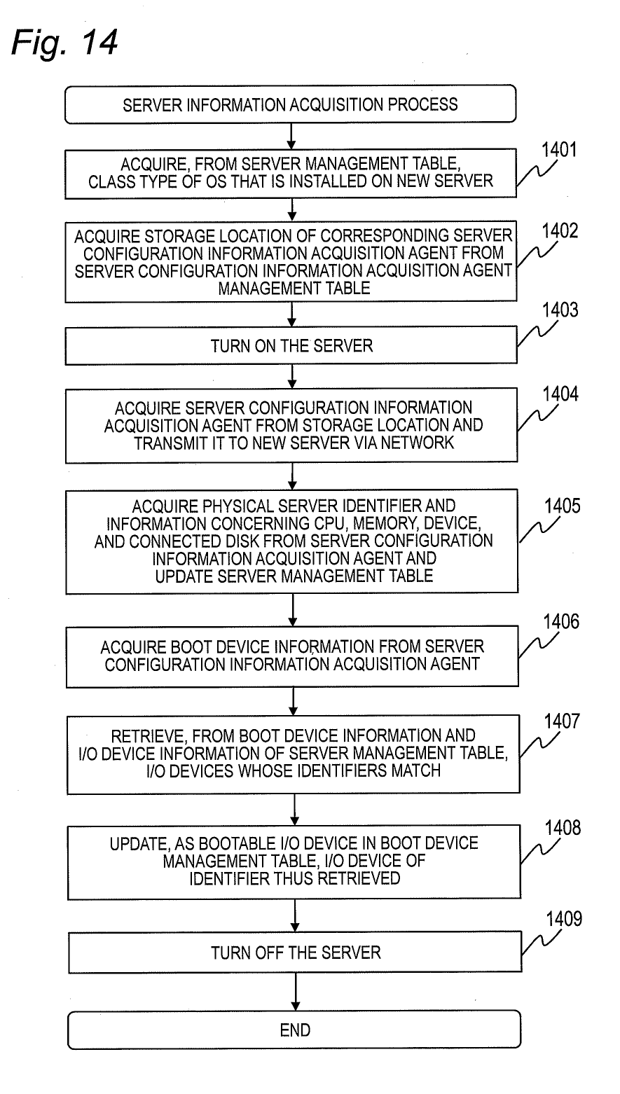

The server information acquisition part 112 acquires the configuration information of the new server from the new server via the network 170. A process that is executed by the server information acquisition part 112 will be described in detail with reference to FIG. 14.

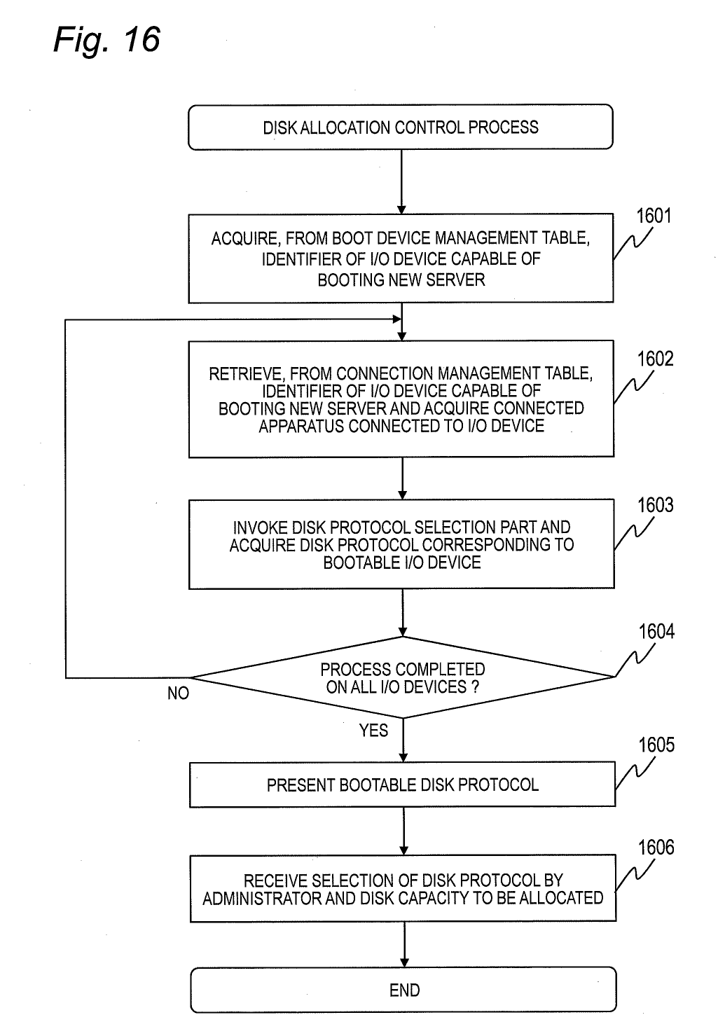

The disk allocation control part 113 outputs an I/O device, among those I/O (Input/Output) devices provided in a physical server 140, to which a device capable of booting the physical server 140 is connected, and receives from the administrator the designation of a boot I/O device for booting the physical server 140. A process that is executed by the disk allocation control part 113 will be described in detail with reference to FIG. 16.

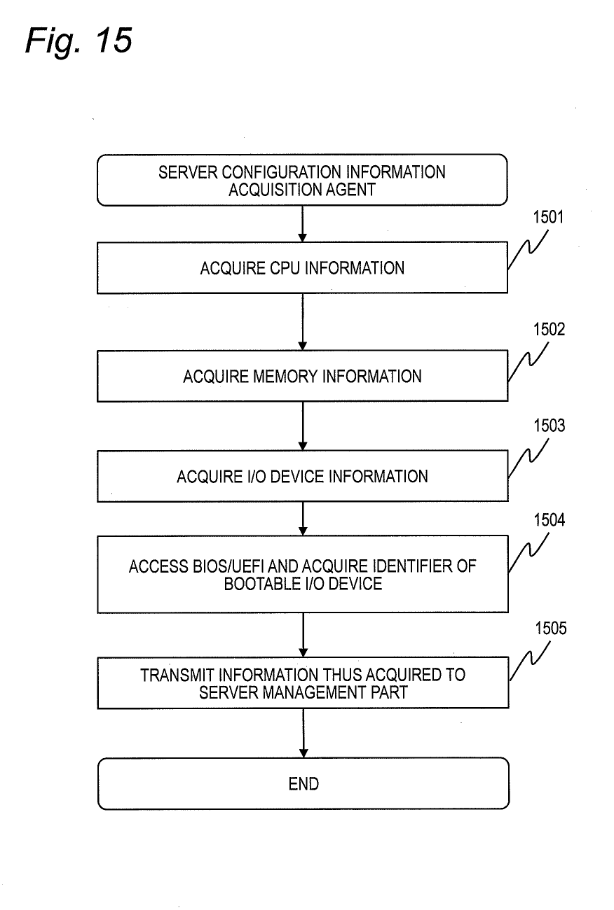

The server configuration information acquisition agent 115 is transmitted to a new server on which no OS has been installed, functions like an OS on the new server, acquires the configuration information of the new server, and transmits the configuration info illation thus acquired to the management server 100. A process that is executed by the server configuration information acquisition agent 115 will be described in detail with reference to FIG. 15.

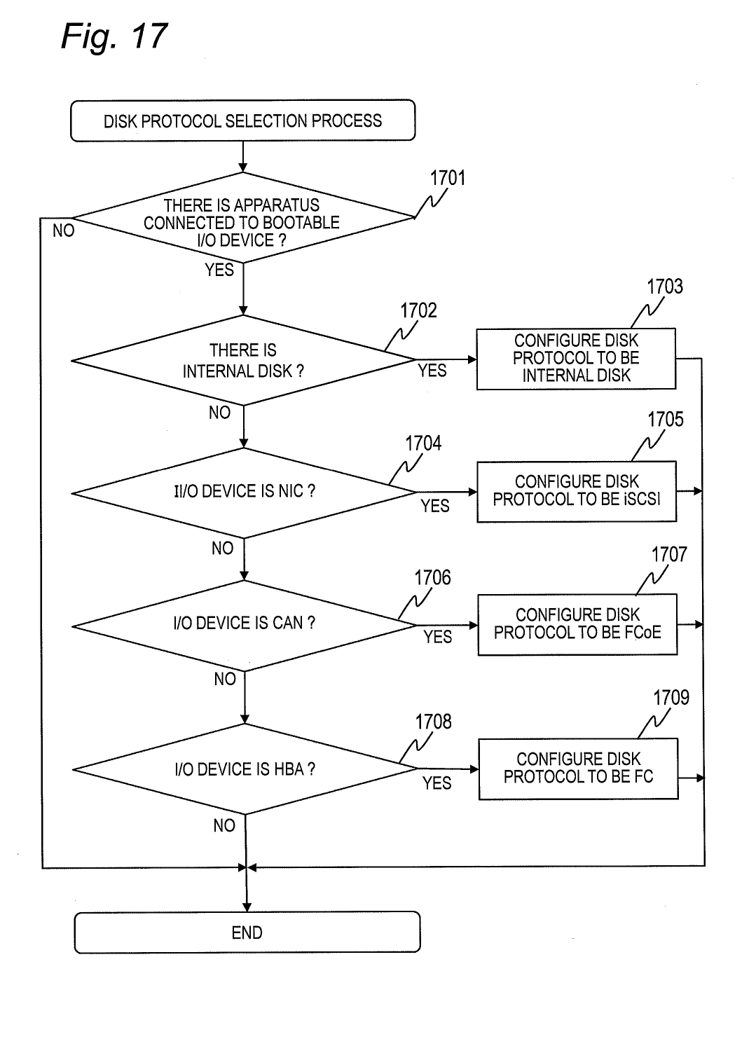

The disk protocol selection part 116 automatically identifies the type of a protocol that is used in communication between an I/O device capable of booting a physical server 140 and a storage device connected to the I/O device. A process that is executed by the disk protocol selection part 116 will be described in detail with reference to FIG. 17.

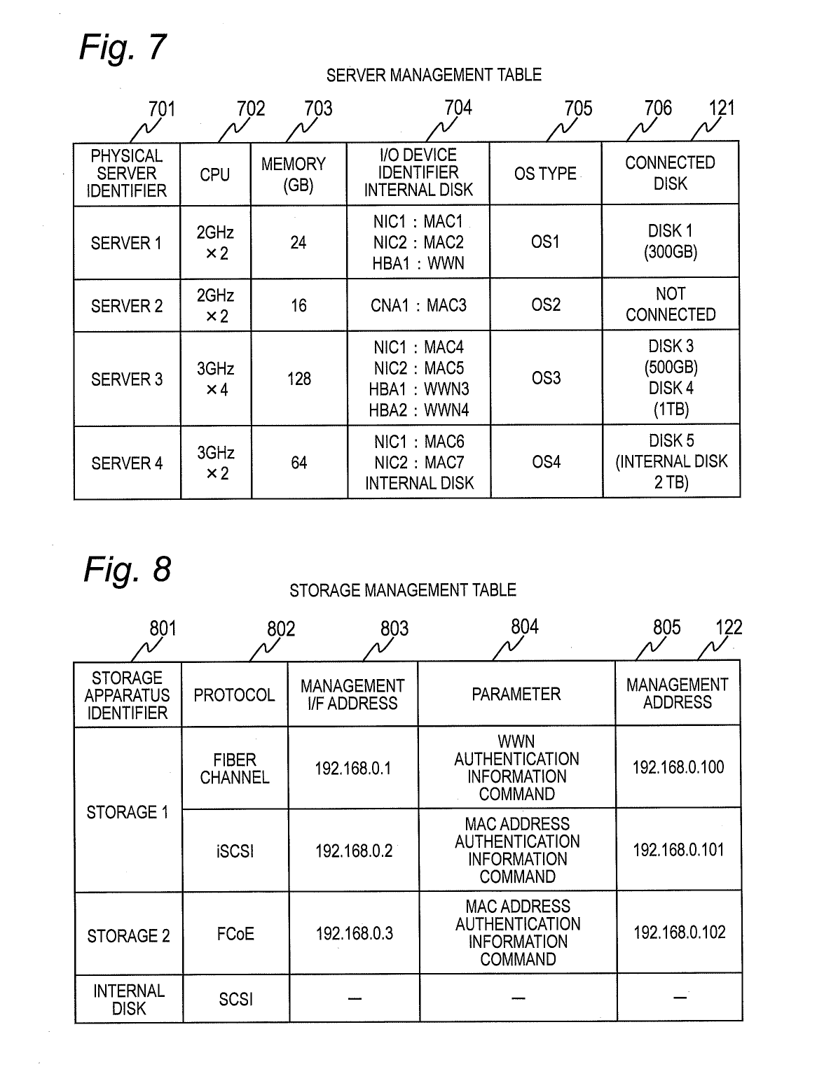

The server management table 121 is a table for managing the configuration information of a physical server 140 that is managed by the server management part 110. The server management table 121 will be described in detail with reference to FIG. 7.

The storage management table 122 is a table for managing information concerning a storage apparatus 150 connected to a physical server that is managed by the server management part 110. The storage management table 122 will be described in detail with reference to FIG. 8.

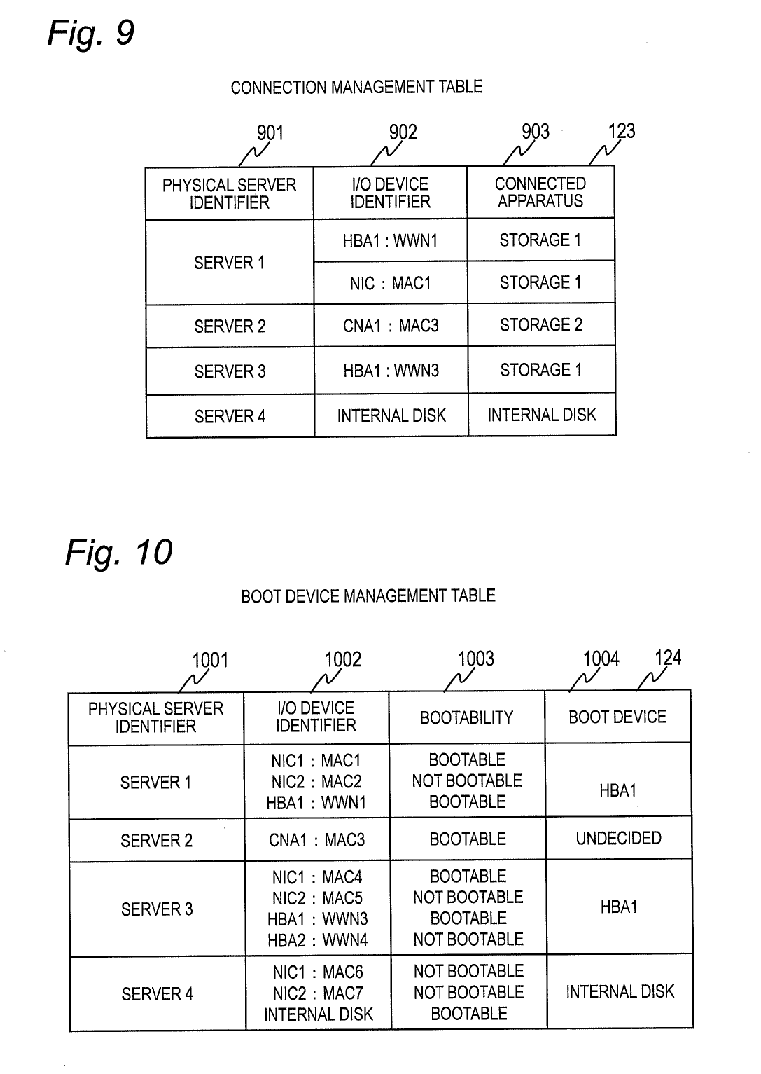

The connection management table 123 is a table for managing a relationship of connection between a physical server 140 and a storage apparatus 150. The connection management table 123 will be described in detail with reference to FIG. 9.

The boot device management table 124 is a table for managing information as to whether or not an I/O device provided in a physical server 140 is capable of booting the physical server 140. The boot device management table 124 will be described in detail with reference to FIG. 10.

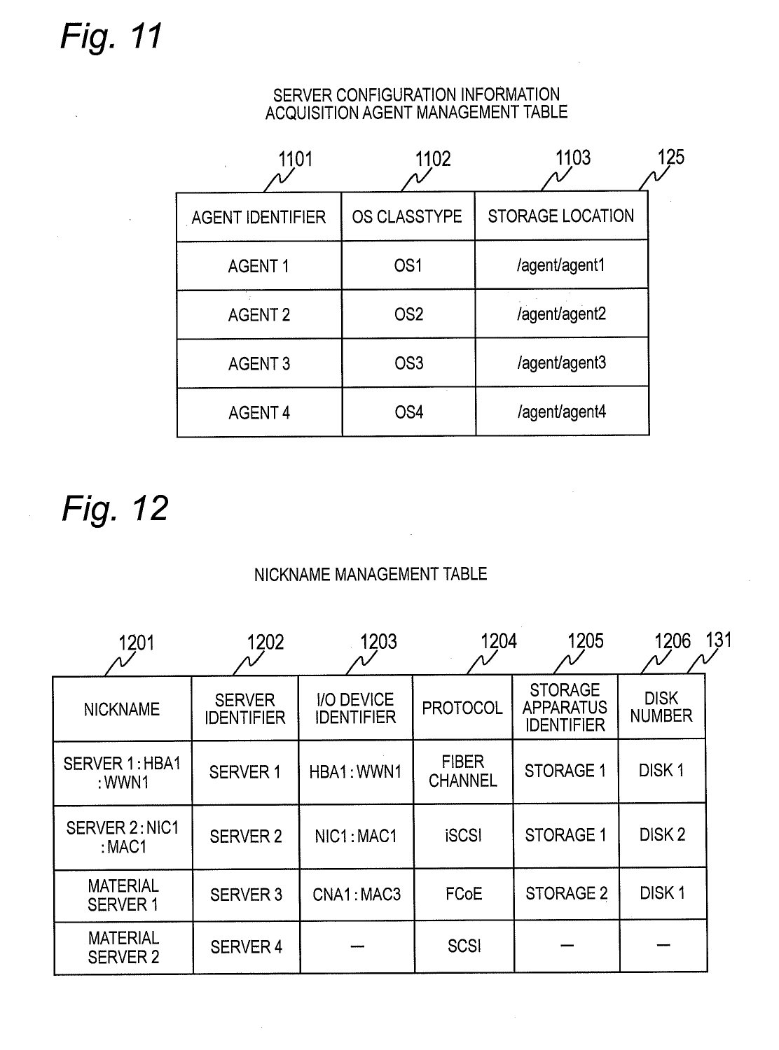

The server configuration information acquisition agent management table 125 is a table for managing each server configuration information acquisition agent, the type of an OS corresponding to the server configuration information acquisition agent, and the storage location of the server configuration information acquisition agent. The server configuration information acquisition agent management table 125 will be described in detail with reference to FIG. 11.

The storage management part 130 includes a nickname management table 131 in which information concerning a physical server 140 is stored from the server management part 110. The nickname management table 131 will be described in detail with reference to FIG. 12.

FIG. 2 is an explanatory diagram of a storage apparatus 150 according to the first embodiment of the present invention.

The storage apparatus 150 includes a management I/F 151, a storage control device 152, and a disk device 153.

As described with reference to FIG. 1, the management I/F 151 is connected to the network 170. The storage apparatus 150 receives various types of data from the management server 100 and the like via the management I/F 151, and transmits various types of data to the management server 100 and the like via the management I/F 151.

The storage control device 152 has control of the storage apparatus 150. On the disk device 153, n logical volumes (LUO to LUn) 154A to 154n (hereinafter collectively referred to as “logical volumes 154”) are generated. When a logical volume 154 is allocated to a physical server 140, the physical server 140 becomes capable of reading and writing various types of data from and to the logical volume 154 allocated thereto.

It should be noted that it is only necessary that at least one logical volume 154 be generated on the disk device 153.

FIG. 3 is an explanatory diagram of the server management part 110 and the storage management part 130 of the management server 100 according to the first embodiment of the present invention.

The server management part 110 manages a physical server 140, and the storage management part 130 manages a storage apparatus 150.

The server management part 110 is connected via the network 170 to the network I/F (interface) 141 provided in the physical server 140. The server management part 110 transmits various types of data to the physical server 140 via the network 170, and receives various types of data from the physical server 140 via the network 170.

The storage management part 130 is connected via the network 170 to the management I/F 150 provided in the storage apparatus 150. The storage management part 130 transmits various types of data to the storage apparatus 150 via the network 170, and receives various types of data from the storage apparatus 150 via the network 170.

In this way, the server management part 110 and the storage management part 130 are both executed in the housing of the same computer, but the server management part 110 and the storage management part 130 manage different objects of management.

It should be noted that the server management part 110 and the storage management part 130 may be executed by different computers.

FIG. 4 is an explanatory diagram of cooperation between the server management part 110 and the storage management part 130 according to the first embodiment of the present invention.

With reference to FIG. 4, cooperation between the server management part 110 and the storage management part 130 in a case where a physical server 140 is newly added is described.

The concept of “a case where a physical server 140 is newly added” here encompasses a case where a physical server 140 on which no OS has been installed yet is added to the network 170 and a case where an OS installed on a physical server 140 having been connected to the network 170 is replaced by another OS so that the physical server 140 can be used for another purpose.

A physical server 140 that is newly added is connected to the storage apparatus 150 via an HBA (Host Bus Adaptor) 142. The HBA 142 is an input-output interface that is connectable to an external device.

In a case where a physical server 140 is newly added, the server management part 110 acquires configuration information from the physical server 140 that is newly added. The configuration information that is acquired by the server management part 110 contains the identifier of the physical server 140 that is newly added and the identifier of an input-output interface provided in the physical server 140 that is newly added.

Then, on the basis of the configuration information thus acquired, the server management part 110 outputs, as candidates for the allocation of a storage area, input-output interfaces connected to the disk device 153 of the storage apparatus 150. Then, upon receiving from the administrator the selection of an input-output interface to which a storage area is allocated, the server management part 110 passes to the storage management part 130 a disk generation request containing the identifier of the new physical server 140 and the identifier of the input-output interface the selection of which has been received.

Upon receiving the disk generation request, the storage management part 130 stores in the nickname management table 131 the identifier of the physical server 140 that is newly added and the identifier of the input-output interface the selection of which has been received, which are contained in the disk generation request. This enables the server management part 110 and the storage management part 130 to share information concerning the new server.

Next, the storage management part 130 configures the settings so that it becomes possible to access, from the input-output interface the selection of which has been received, at least one logical volume 154 generated in the disk device 153 connected to the input-output interface, and allocates the logical volume 154 to the physical server 140 that is newly added. This causes a disk to be generated on the physical server 140 that is newly added.

This enables the storage management part 130 to acquire the identifier of the new physical server 140 and the identifier of the input-output interface the selection of which has been received, which are required for the allocation of a logical volume 154, and enables the server management part 110 and the storage management part 130 to cooperate with each other. This makes it possible to improve the management efficiency with which a logical volume 154 is allocated to a physical server 140.

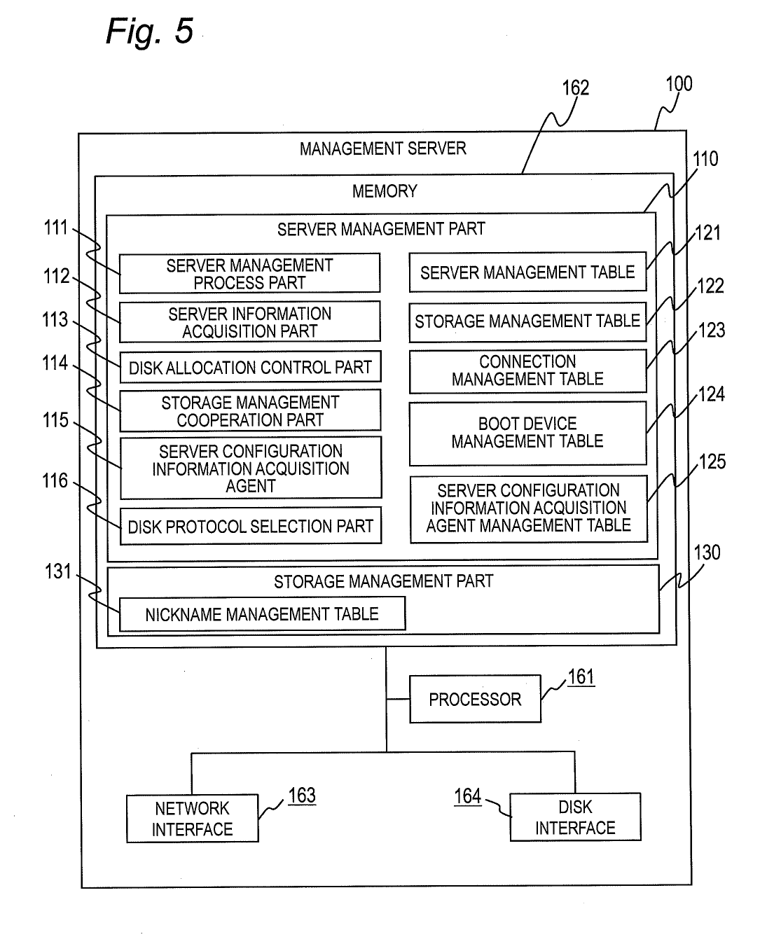

FIG. 5 is a hardware configuration diagram of the management server 100 according to the first embodiment of the present invention.

The management server 100 includes a processor 161, a memory 162, a network interface 163, and a disk interface 164.

The processor 161 executes various types of program stored in the memory 162. In the memory 162, a program corresponding to the server management part 110 and a program corresponding to the storage management part 130 are stored.

The program corresponding to the server management part 110 contains a subprogram corresponding to the server management process part 111, a subprogram corresponding to the server information acquisition part 112, a subprogram corresponding to the disk allocation control part 113, a subprogram corresponding to the storage management cooperation part 114, a subprogram corresponding to the server configuration information acquisition agent 115, and a subprogram corresponding to the disk protocol selection part 116.

Further, the program corresponding to the server management part 110 contains the server management table 121, the storage management table 122, the connection management table 123, the boot device management table 124, and the server configuration information acquisition agent management table 125.

The network interface 163 is an interface for the server management part 110 to access a physical server 140 via the network 170. The disk interface 164 is an interface for the storage management part 130 to access a storage apparatus 150 via the network 170.

In FIG. 5, the network interface 163, which the server management part 110 utilizes, and the disk interface 164, which the storage management part 130 utilizes, are separate. Alternatively, the server management part 110 and the storage management part 130 may utilize a single interface connected to the network 170.

Further, the programs that realize the functions of the respective parts described above do not need to be stored in a single memory, but may be dispersedly stored in memories of a plurality of computers so that the functions of the management server 100 may be realized by the plurality of computers.

Further, information such as the programs, tables, and files that realize the respective functions can be stored in a storage device such as a nonvolatile semiconductor memory, a hard disk drive, or an SSD (Solid State Drive) or in a computer-readable non-transitory data storage medium such as an IC card, an SD card, or a DVD.

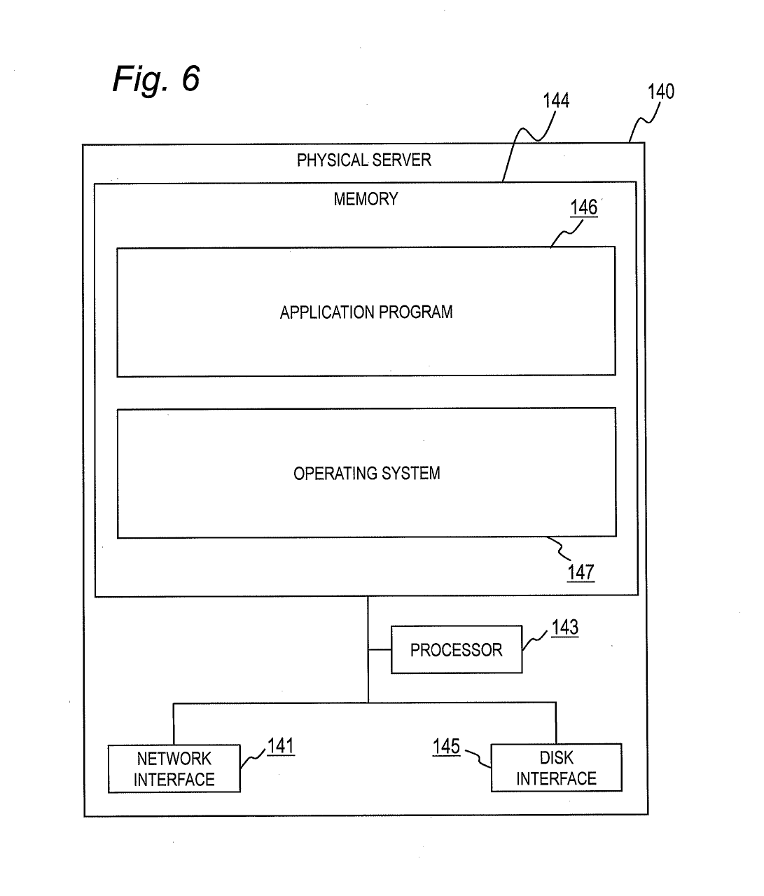

FIG. 6 is a hardware configuration diagram of a physical server 140 according to the first embodiment of the present invention.

The physical server 140 includes a processor 143, a memory 144, a network interface 141, and a disk interface 145.

The processor 143 executes various types of program stored in the memory 144. In the memory 144, an application program 146 and an operating system (OS) 147 are stored. The operating system 147 is a program that has basic control of the physical server 140.

To the network interface 141, the network 170 is connected. To the disk interface 145, the disk device 153 of a storage apparatus 150 is connected. These interfaces are referred to as “input-output interfaces (I/O devices)” of the physical server 140.

FIG. 7 is an explanatory diagram of the server management table 121 according to the first embodiment of the present invention.

The server management table 121 is a table for the server management part 110 to manage various types of information on a physical server 140.

The server management table 121 contains a physical server identifier 701, a CPU 702, a memory 703, an I/O device identifier 704, an OS type 705, and a connected disk 706.

In the physical server identifier 701, the unique identifier of a physical server 140 is entered. In the CPU 702, the performance information of the processor 143 of a physical server 140 is entered. Specifically, in the CPU 702, the number of clocks per core and the number of cores in the processor 143 of a physical server 140 are entered.

In the memory 703, the performance information of the memory 144 of a physical server 140 is entered. Specifically, in the memory 703, the capacity (GB) of the memory 144 of a physical server 140 is entered.

In the I/O device identifier 704, the identifier of an I/O device provided in a physical server 140 is entered. Types of identifier that are entered in the I/O device identifier 704 vary depending on the type of an I/O device. Specifically, in a case where the type of an I/O device is an NIC (Network Interface Card), the MAC address of the NIC is entered in the I/O device identifier 704. Further, in a case where the type of an I/O device is an HBA, the WWN (World Wide Name) of the HBA is entered in the I/O device identifier 704. Further, in a case where the type of an I/O device is a CNA (Converged Network Adapter), the MAC address of the CNA is entered in the I/O device identifier 704. Furthermore, an internal disk provided in a physical server 140 may be entered in the I/O device identifier 704.

In the OS type 705, the type of an OS installed or to be installed on a physical server 140 is entered.

In the connected disk 706, the identifier of the disk device 153 of a storage apparatus 150 connected to an I/O device of a physical server 140 is entered.

FIG. 8 is an explanatory diagram of the storage management table 122 according to the first embodiment of the present invention.

The storage management table 122 is a table for the server management part 110 to manage various types of information on a storage apparatus 150. Various types of information that are entered in the storage management table 122 are configured in advance by the administrator.

The storage management table 122 contains a storage apparatus identifier 801, a protocol 802, a management I/F address 803, an parameter 804, and a management address 805.

In the storage apparatus identifier 801, the identifier of a storage apparatus 150 is entered. In the protocol 802, the name of a protocol that is utilized in communication between a storage apparatus 150 and a physical server 140 connected to the storage apparatus 150 is entered. In the management I/F address 803, the address of the management I/F 151 of a storage apparatus 150 is entered.

In the parameter 804, information required for the server management part 110 to pass a disk generation request to a storage apparatus 150 is entered. Specifically, in the parameter 804, the identifier (for example, WWN, MAC address, etc.) of an I/O device to which a logical volume 154 is allocated, authentication information containing a user name and a password, and a disk generation command are entered.

In the management address 805, the address of the disk interface 164, which is utilized by the storage management part 130, which manages a storage apparatus 150, is entered.

FIG. 9 is an explanatory diagram of the connection management table 123 according to the first embodiment of the present invention.

The connection management table 123 is a table for the server management part 110 to manage a relationship of connection between a physical server 140 and a storage apparatus 150. It should be noted that in a case where a new physical server 140 has been added, a relationship of connection between the physical server 140 and a storage apparatus 150 connected to the physical server 140 is entered in the connection management table 123 by the administrator.

The connection management table 123 contains a physical server identifier 901, an I/O device identifier 902, and a connected apparatus 903.

In the physical server identifier 901, the identifier of a physical server 140 is entered. In the I/O device identifier 902, the identifier of an I/O device, among those I/O devices provided in a physical server 140, which is connected to a storage apparatus 150 or to an internal disk is entered. In the connected apparatus 903, the identifier of a storage apparatus 150 or internal disk connected to an I/O device provided in a physical server 140.

FIG. 10 is an explanatory diagram of the boot device management table 124 according to the first embodiment of the present invention.

The boot device management table 124 is a table for the server management part 110 to manage an I/O device capable of booting a physical server 140.

The boot device management table 124 contains a physical server identifier 1001, an I/O device identifier 1002, bootability 1003, and a boot device 1004.

In the physical server identifier 1001, the identifier of a physical server 140 is entered. In the I/O device identifier 1002, the identifier of an I/O device provided in a physical server 140 is entered. In the bootability 1003, information indicating whether or not an I/O device provided in a physical server 140 is capable of booting the physical server 140 is entered. In the boot device 1004, the identifier of an I/O device that boots a physical server 140 is entered.

FIG. 11 is an explanatory diagram of the server configuration information acquisition agent management table 125 according to the first embodiment of the present invention.

The server configuration information acquisition agent management table 125 is a table for the server management part 110 to mange an OS corresponding to a server configuration information acquisition agent 115 and the storage location of the server configuration information acquisition agent 115.

The server configuration information acquisition agent management table 125 contains an agent identifier 1101, an OS type 1102, and a storage location 1103.

In the agent identifier 1101, the identifier of a server configuration information acquisition agent 115 is entered. In the OS type 1102, the type of an OS corresponding to a server configuration information acquisition agent 115 is entered. In the storage location 1103, the storage location of a server configuration information acquisition agent 115 is entered. It should be noted that “a server configuration information acquisition agent 115 corresponds to the type of an OS” means that in a case where a server configuration information acquisition agent 115 is executed on a physical server 140, the server configuration information acquisition agent 115 realizes on the physical server 140 the functions of an OS corresponding thereto.

FIG. 12 is an explanatory diagram of the nickname management table 131 according to the first embodiment of the present invention.

The nickname management table 131 is a table for the storage management part 130 to manage a relationship between an I/O device of a physical server 140 to which a logical volume 154 has been allocated and the disk device 153 of the logical volume 154.

The nickname management table 131 contains a nickname 1201, a server identifier 1202, an I/O device identifier 1203, a protocol 1204, a storage apparatus identifier 1205, and a disk number 1206.

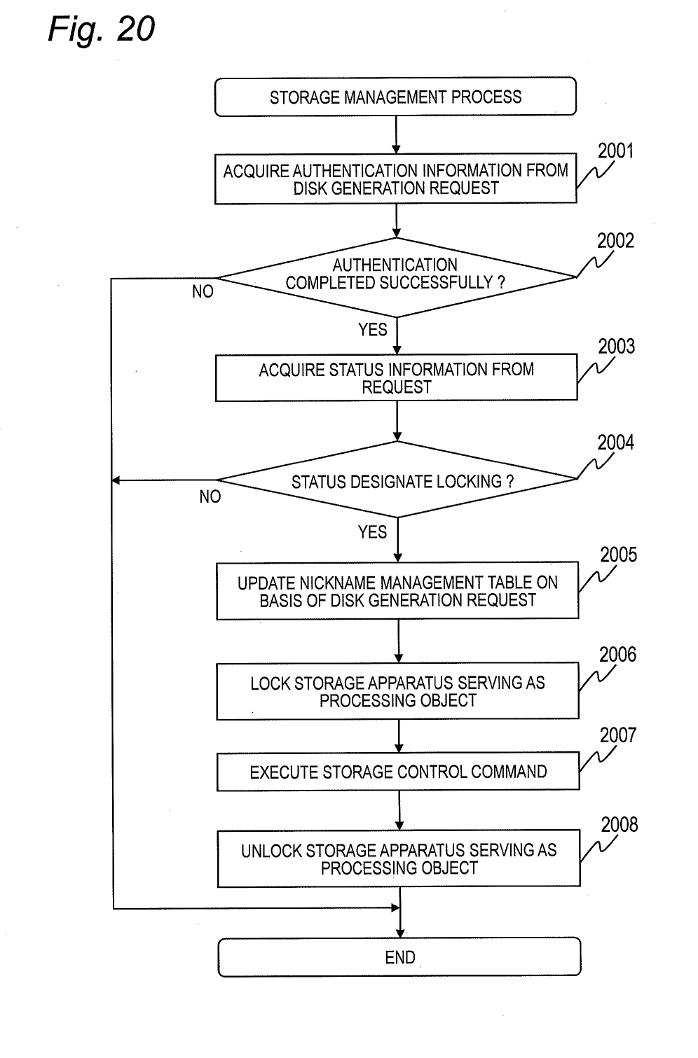

In the nickname 1201, a nickname generated by the server management part 110 on the basis of the identifier of a physical server 140 to which a logical volume 154 is allocated and the identifier of an I/O device to which the logical volume 154 is allocated is entered. A process for generating a nickname will be described in detail with reference to FIG. 20.

In the server identifier 1202, the identifier of a physical server 140 to which a logical volume 154 is allocated is entered. In the I/O device identifier 1203, the identifier of an I/O device to which a logical volume 154 is allocated is entered.

In the protocol 1204, the type of a protocol that is used in communication between an I/O device and a storage device connected to the I/O device is entered. In the storage apparatus identifier 1205, the identifier of a storage apparatus 150 that provides a physical server 140 with a logical volume 154 is entered. In the disk number 1206, the identifier of a disk device 153, among those disk devices 153 provided in the storage apparatuses 150, which provides a physical server 140 with a logical volume 154 and on which a logical volume 154 has been generated is entered.

FIG. 13 is a flow chart of a server management process according to the first embodiment of the present invention.

The server management process is executed by the processor 161 executing the program corresponding to the server management process part 111.

First, the processor 161 receives a request from an administrator (1301). The request from the administrator includes various requests, including a request to add a new physical server 140.

Next, the processor 161 determines whether or not the request received in step 1301 is a request to add a new physical server 140 (1302).

In a case where the processor 161 has determined in step 1302 that the request received in step 1301 is not a request to add a new physical server 140, the processor 161 executes a process corresponding to the request thus received (1303), and ends the sever management process.

On the other hand, in a case where the processor 161 has determined in step 1302 that the request received in step 1301 is a request to add a new physical server 140, the processor 161 invokes the program corresponding to the server information acquisition part 112, and executes a server configuration information acquisition process for acquiring the configuration information of the physical server 140 that is newly added (1304). It should be noted that the server configuration information acquisition process will be described in detail with reference to FIG. 14.

It should be noted here that the request to add a new physical server 140 contains the identifier of a new physical server 140 and the type of an OS to be installed on the new physical server 140. In step 1340, the processor 161 adds a new entry to the server management table 121. Then, the processor 161 enters, in the physical server identifier 701 of the entry, the identifier of the new physical server 140 as contained in the request to add a new physical server 140, and enters, in the OS type 705 of the entry, the type of the OS to be installed on the new physical server 140 as contained in the request to add a new physical server 140.

Next, the processor 161 invokes the program corresponding to the disk allocation control part 113, and executes a disk allocation control process for deciding how to boot the physical server 140 that is newly added (1305). It should be noted that the disk allocation control process will be described in detail with reference to FIG. 16.

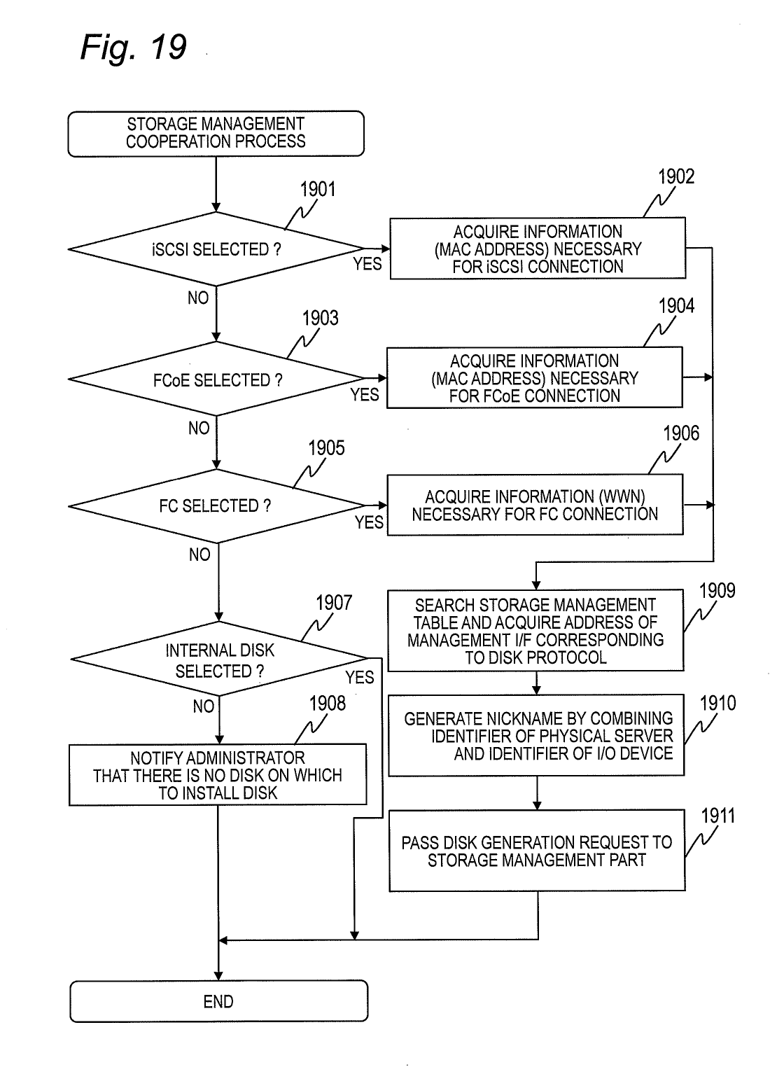

Next, the processor 161 invokes the program corresponding to the storage management cooperation part 114, executes a storage management cooperation process for passing to the storage management part 130 a disk generation request to allocate a logical volume 154 to the physical server 140 that is newly added (1306), and ends the server management process. It should be noted that the storage management cooperation process will be described in detail with reference to FIG. 19.

FIG. 14 is a flow chart of the server information acquisition process according to the first embodiment of the present invention.

The server information acquisition process is executed by the processor 161 executing the program corresponding to the server information acquisition part 112.

First, the processor 161 refers to the OS type 705 of the server management table 121 and acquires the type of an OS to be installed on the new physical server 140 (1401).

Next, the processor 161 refers to the server configuration information acquisition agent management table 125 and acquires the storage location of a server configuration information acquisition agent 115 corresponding to the type of the OS to be installed on the new physical server 140 (1402).

Specifically, the processor 161 selects, from among those entries in the server configuration information acquisition agent management table 125, an entry in which the type of an OS as entered in the OS type 1102 matches the type of the OS as acquired in step 1401. Then, the processor 161 acquires the storage location of a server configuration information acquisition agent 115 as entered in the storage location 1103 of the entry thus selected.

Next, the processor 161 confirms that the new physical server 140 is on (1403), acquires the server configuration information acquisition agent 115 from the storage location acquired in step 1402, and transmits the server configuration information acquisition agent 115 thus acquired to the new physical server 140 via the network 170 (1404). It should be noted that the server configuration information acquisition agent 115 generates on the new physical server 140 the same environment as that of the OS to be installed on the physical server 140, and acquires the configuration information of the physical server 140.

Next, the processor 161 acquires, from the server configuration information acquisition agent 115 transmitted to the new physical server 140 in step 1404, configuration information containing the performance information of the processor 143 provided in the physical server 140, the performance information of the memory 144, the identifier of an I/O device, and the identifier of a storage apparatus 150 connected to the new physical server 140, and updates the server management table 121 with the configuration information thus acquired (1405).

Specifically, the processor 161 selects, from among those entries entered in the server management table 121, an entry whose physical server identifier 701 matches the identifier of the new physical server 140. Then, the processor 161 enters, in the CPU 702 of the entry thus selected, the performance information of the processor 143 as acquired, enters, in the memory 703 of the entry thus selected, the performance information of the memory 144 as acquired, enters, in the I/O device identifier 704 of the entry thus selected, the identifier of the I/O device as acquired, and enters, in the connected disk 706 of the entry thus selected, the identifier of the disk device 153 of the storage apparatus 150 connected to the physical server 140 as acquired.

Next, the processor 161 acquires, from the server configuration information acquisition agent 115 transmitted to the new physical server 140 in step 1404, boot device information containing the identifier of an I/O device, among those I/O devices provided in the new physical server 140, which is capable of booting the physical server 140 (1406). It should be noted that in a case where an I/O device (boot device) that boots the new physical server 140 has been configured, the boot device information contains the identifier of the boot device.

Then, the processor 161 retrieves, from among the identifiers of I/O devices as entered in the I/O device identifier 704 of the server management table 121, the identifier of an I/O device that matches the identifier of the bootable I/O device as contained in the boot device information acquired in step 1406 (1407).

Then, the processor 161 updates the boot device management table 124 (1408). Specifically, the processor 161 adds a new entry to the boot device management table 124 and enters, in the I/O device identifier 1002 of the entry thus added, the identifier of an I/O device as entered in the I/O device identifier 704 of an entry that matches the identifier of the new physical server 140 in the server management table 121. Then, in step 1407, the processor 161 enters “bootable” in the bootability 1003 in association with the identifier of an I/O device that matches the identifier of the bootable I/O device as contained in the boot device information, and in step 1407, enters “not bootable” in the bootability 1003 in association with the identifier of an I/O device that does not match the identifier of the bootable I/O device as contained in the boot device information. Furthermore, in a case where the boot device information acquired in step 1406 contains the identifier of a boot device, the processor 161 enters the identifier of the boot device in the boot device 1004.

Next, the processor 161 transmits to the new physical server 140 a command to turn on the new physical server 140 (1409), and ends the server information acquisition process.

FIG. 15 is a flow chart of a process that is executed by a server configuration information acquisition agent 115 according to the first embodiment of the present invention.

The processor 143 of a physical server 140 having received a server configuration information acquisition agent 115 executes the server configuration information acquisition agent 115 thus received, whereby the process shown in FIG. 15 is executed.

First, the processor 143 acquires the performance information of the processor 143 (1501), acquires the performance information of the memory 144 (1502), and acquires the identifier of an I/O device (1503).

Next, the processor 143 accesses a BIOS or UEFI and acquires the identifier of an I/O device capable of booting the physical server 140 (1504).

Then, the processor 143 transmits to the server management part 110 of the management server 100 the information acquired in steps 1501 through 1504 (1505), and ends the process.

FIG. 16 is a flow chart of the disk allocation control process according to the first embodiment of the present invention.

The disk allocation control process is executed by the processor 161 executing the program corresponding to the disk allocation control part 113.

First, the processor 161 refers to the boot device management table 124 and acquires the identifier of an I/O device, among those I/O devices provided in the new physical server 140, which is capable of booting the physical server 140 (1601).

Specifically, the processor 161 selects, from among those entries in the boot device management table 124, an entry in which the identifier of a physical server 140 as entered in the physical server identifier 1001 matches the identifier of the new physical server 140. Then, the processor 161 acquires the identifier of an I/O device, among the identifiers of I/O devices as entered in the I/O device identifier 1002 of the entry thus selected, whose bootability 1003 is “bootable”.

Next, the processor 161 refers to the connection management table 123 and acquires the identifier of a storage apparatus 150 or internal disk connected to the bootable I/O device (1602).

Specifically, the processor 161 selects, from among those entries entered in the connection management table 123, entries whose physical server identifiers 901 match the identifier of the new physical server 140. Then, the processor 161 acquires the identifier of a storage apparatus 150 or internal disk as entered in the connected apparatus 903 of an entry, among those entries thus selected, whose I/O device identifier 902 matches the identifier of the I/O device as acquired in step 1601.

Next, the processor 161 invokes the disk protocol selection part 116, and executes a disk protocol selection process for acquiring a protocol (disk protocol) that is utilized in communication between an bootable I/O device and an apparatus connected to the I/O device (1603). The disk protocol selection process will be described in detail with reference to FIG. 17.

Next, the processor 161 determines whether or not steps 1602 and 1603 have been executed on the identifiers of all the bootable I/O devices as acquired in step 1601 (1604).

In a case where the processor 161 has determined in step 1604 that steps 1602 and 1603 have not been executed on the identifiers of all the bootable I/O device as acquired in step 1601, the processor 161 returns to step 1602, in which the processor 161 executes steps 1602 and 1603 on the identifier of a bootable I/O device on which steps 1602 and 1603 have not been executed yet.

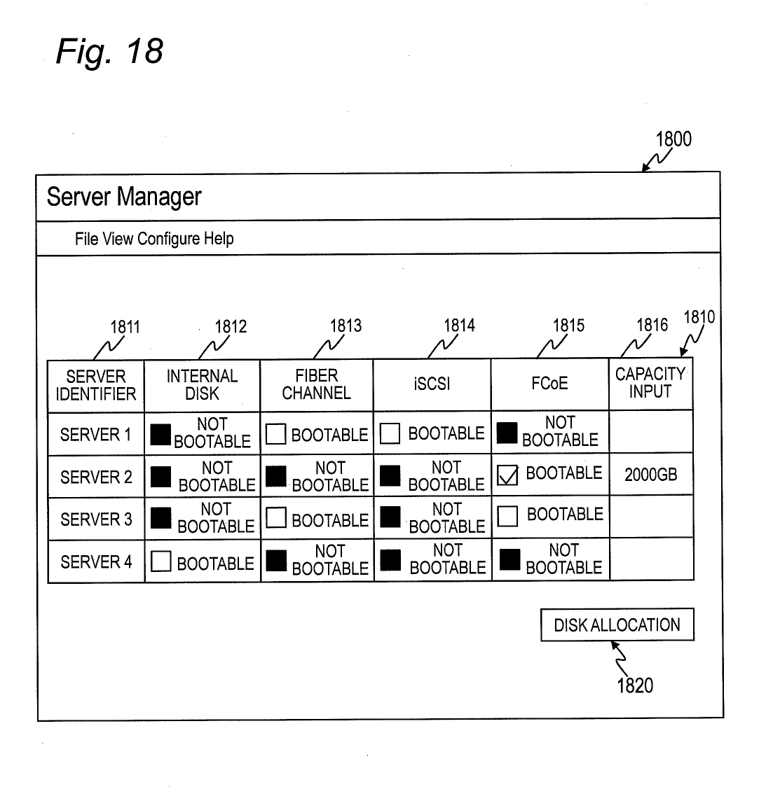

On the other hand, in a case where the processor 161 has determined in step 1604 that steps 1602 and 1603 have been executed on the identifiers of all the bootable I/O devices as acquired in step 1601, the processor 161 displays on a display (not illustrated) a server management screen 1800 for presenting a bootable disk protocol (1605). The server management screen 1800 will be described in detail with reference to FIG. 18. The display (not illustrated) may be provided in a client computer connected to the management server 100 via the network, or may be provided in the management server 100.

Next, the processor 161 receives, from the administrator via the server management screen 1800, an allocation command containing the designation of the type of an I/O device to which a logical volume 154 is allocated and the designation of the capacity of the logical volume 154 that is allocated (1606), and ends the disk allocation control process. For example, in a case where the server management screen 1800 is displayed on a display of a client computer (not illustrated), the client computer (not illustrated), upon receiving an allocation command via the server management screen 1800, transmits the allocation command to the management server 100, and the management server 100 receives the allocation command by receiving the allocation command.

FIG. 17 is a flow chart of the disk protocol selection process according to the first embodiment of the present invention.

The disk protocol selection process is executed by the processor 161 executing the program corresponding to the disk protocol selection part 116.

First, the processor 161 refers to the identifier of the storage apparatus 150 or internal disk as acquired in step 1602 shown in FIG. 16 and determines whether or not there is an apparatus that is connected to a bootable I/O device provided in the new physical server 140 (1701).

In a case where the processor 161 has determined in step 1701 that there is no apparatus that is connected to a bootable I/O device provided in the new physical server 140, the processor 161 ends the disk protocol selection process, as there is no disk protocol, either.

On the other hand, in a case where the processor 161 has determined in step 1701 that there is an apparatus that is connected to a bootable I/O device provided in the new physical server 140, the processor 161 refers to the identifier of the storage apparatus 150 or internal disk as acquired in step 1602 shown in FIG. 16 and determines whether or not the apparatus that is connected to the bootable I/O device is the internal disk (1702).

In a case where the processor 161 has determined in step 1702 that the apparatus that is connected to the bootable I/O device is the internal disk, the processor 161 configures the disk protocol to be internal disk (1703), and ends the disk protocol selection process.

In a case where the processor 161 has determined in step 1702 that the apparatus that is connected to the bootable I/O device is not the internal disk, the processor 161 determines whether or not the bootable I/O device is an NIC (1704).

In a case where the processor 161 has determined in step 1704 that the bootable I/O device is an NIC, the processor 161 configures the disk protocol to be iSCSI (1705), and ends the disk protocol selection process.

On the other hand, in a case where the processor 161 has determined in step 1704 that the bootable I/O device is not an NIC, the processor 161 determines whether or not the bootable I/O device is a CNA (1705).

In a case where the processor 161 has determined in step 1705 that the bootable I/O device is a CNA, the processor 161 configures the disk protocol to be FCoE (Fiber Channel over Ethernet) (1706), and ends the disk protocol selection process.

In a case where the processor 161 has determined in step 1705 that the bootable I/O device is not a CNA, the processor 161 determines whether or not the bootable I/O device is an HBA (1708).

In a case where the processor 161 has determined in step 1708 that the bootable I/O device is an HBA, the processor 161 configures the disk protocol to be FC (Fiber Channel) (1709), and ends the disk protocol selection process.

In a case where the processor 161 has determined in step 1708 that the bootable I/O device is not an HBA, the processor 161 ends the disk protocol selection process.

This is how a disk protocol corresponding to a bootable I/O device is configured.

FIG. 18 is an explanatory diagram of the server management screen 1800 according to the first embodiment of the present invention.

The server management screen 180 contains a presentation field 1810 and a disk allocation button 1820. The presentation field 1810 presents information as to the bootability of each disk protocol for each physical server 140.

The presentation field 1810 contains a server identifier 1811, an internal disk 1812, a fiber channel 1813, an iSCSI 1814, an FCoE 1815, and a capacity input 1816.

The server identifier 1811 displays the identifier of each physical server 140. The server identifier 1811, the internal disk 1812, the fiber channel 1813, the iSCSI 1814, and the FCoE 1815 display information as to which physical server 140 can be booted by using which disk protocol, and a checkbox for each bootable disk protocol allows that bootable disk protocol to be chosen by the administrator's operation.

The capacity input 1816 is a field in which for the administrator to input the capacity of a logical volume 154 that is allocated to a physical server 140.

Pressing the disk allocation button 1820 causes the server management part 110 to receive an allocation command to allocate, to an I/O device corresponding to the selected disk protocol of the selected physical server 140, a logical volume 154 for booting the physical server 140.

The allocation command contains the identifier of the selected physical server 140, the selected disk protocol, and the capacitor of the logical volume 154 as inputted.

It should be noted that pressing the disk allocation button 1820 causes a screen for inputting authentication information containing a user name and a password to be displayed, so that the administrator can input the authentication information via the screen. The allocation command also contains the authentication information inputted by the administrator.

FIG. 19 is a flow chart of the storage management cooperation process according to the first embodiment of the present invention.

The storage management cooperation process is executed by the processor 161 executing the program corresponding to the storage management cooperation part 114.

First, the processor 161 determines whether or not the disk protocol selected by the administrator and contained in the allocation command is iSCSI (1901).

In a case where the processor 161 has determined in step 1901 that the disk protocol selected by the administrator and contained in the allocation command is iSCSI, the processor 161 refers to the boot device management table 124, acquires the identifier (MAC address) of an I/O device corresponding to the selected disk protocol iSCSI (1902), and proceeds to step 1909. The identifier of the I/O device as acquired in step 1902 serves as the identifier (allocation destination I/O device identifier) of an I/O device of the physical server 140 to which the logical volume 154 is allocated.

Specifically, the processor 161 selects, from among those entries in the boot device management table 124, an entry whose physical server identifier 1001 matches the identifier, contained in the allocation command, of the physical server 140 selected by the administrator. Then, with reference to the bootability 1003, the processor 161 acquires the identifier of an I/O device, among the identifiers of I/O devices as entered in the I/O device identifier 1002 of the entry thus selected, which is both the identifier of a bootable I/O device and an MAC address.

On the other hand, in a case where the processor 161 has determined in step 1901 that the disk protocol selected by the administrator and contained in the allocation command is not iSCSI, the processor 161 determines whether or not the disk protocol selected by the administrator is FCoE (1903).

In a case where the processor 161 has determined in step 1903 that the disk protocol selected by the administrator is FCoE, the processor 161 refers to the boot device management table 124, acquires the identifier (MAC address) of an I/O device corresponding to the selected disk protocol FCoE (1904), and proceeds to step 1909. The identifier of the I/O device as acquired in step 1904 serves as an allocation destination I/O device identifier.

The specific method of acquisition is the same as that employed in step 1902, and as such, is not described here.

In a case where the processor 161 has determined in step 1903 that the disk protocol selected by the administrator is not FCoE, the processor 161 determines whether or not the disk protocol selected by the administrator is FC (1905).

In a case where the processor 161 has determined in step 1905 that the disk protocol selected by the administrator is FC, the processor 161 refers to the boot device management table 124, acquires the identifier (WWN) of an I/O device corresponding to the selected disk protocol FC (1906), and proceeds to step 1909. The identifier of the I/O device as acquired in step 1906 serves as an allocation destination I/O device identifier.

The specific method of acquisition is different from that employed in step 1902 in that with reference to the bootability 1003, the processor 161 acquires the identifier of an I/O device, among the identifiers of I/O devices as entered in the I/O device identifier 1002 of the entry thus selected, which is both the identifier of a bootable I/O device and a WWN.

On the other hand, in a case where the processor 161 has determined in step 1905 that the disk protocol selected by the administrator is not FC, the processor 161 determines whether or not the disk protocol selected by the administrator is internal disk (1907).

In a case where the processor 161 has determined in step 1907 that the disk protocol selected by the administrator is not internal disk, the processor 161 notifies the administrator that there is no storage area (disk) having stored therein an OS to be installed on the physical server 140 selected by the administrator (1908), and ends the storage management cooperation process.

On the other hand, in a case where the processor 161 has determined in step 1907 that the disk protocol selected by the administrator is internal disk, the processor 161 ends the storage management cooperation process, as it is not necessary to allocate a logical volume 154 in a storage apparatus 150 to the physical server 140.

Steps 1909 and 1910, which are executed after step 1902, 1904, or 1906, are described here. In these steps, the storage management part 130 is notified of information that the server management part 110 retains, in order that a logical volume 154 for installing an OS is allocated to the physical server 140 selected by the administrator.

First, the processor 161 refers to the storage management table 122 and acquires a management I/F address corresponding to the disk protocol selected by the administrator (1909). This management I/F address serves as a destination to which the storage management part 130 transmits a command to allocate a logical volume 154.

Specifically, the processor 161 selects, from among those entries in the storage management table 122, an entry in which the protocol entered in the protocol 802 matches the disk protocol selected by the administrator and matches the storage apparatus identifier, and acquires the address entered in the management I/F address 803 of the entry.

Next, the processor 161 generates a nickname by combining the identifier of the physical server 140 selected by the administrator and the allocation destination I/O device identifier acquired in step 1902, 1904, or 1906 (1910). An example of how to generate the nickname is to simply couple the identifier of the physical server 140 and the allocation destination I/O device identifier. The nickname is a name which makes it possible to identify the physical server 140 to which a logical volume 154 is allocated, and which is easy for the administrator to recognize.

Next, the processor 161 invokes the storage management part 130 by passing to the storage management part 130 a disk generation request to allocate a logical volume 154 to the allocation destination I/O device (1911), and ends the storage management cooperation process.

The disk generation request contains the nickname generated in step 1910, the identifier of the physical server 140 selected by the administrator, the allocation destination I/O device identifier, the authentication information inputted by the administrator, the allocated capacity designated by the administrator, the management I/F address acquired in step 1909, status information, and a disk generation command. The status information is information that designates the status of a storage apparatus that the storage management part 130 controls. The status information contained in the disk generation request designates a status in which a storage apparatus 150 serving as a processing object is locked so that the storage apparatus 150 does not execute a process from software or the like other than the storage management part 130 to which the server management part 110 passed the disk generation request.

FIG. 20 is a flow chart of a storage management process according to the first embodiment of the present invention.

The storage management process is executed by the processor 161 executing the program corresponding to the storage management part 130.

First, the processor 161 acquires the authentication information contained in the disk generation request received by the storage management part 130 (2001).

Then, the processor 161 determines whether or not the authentication information acquired in step 2001 is legitimate authentication information (2002). The legitimate authentication information is a legitimate user name and a legitimate password, and a relationship therebetween is retained by the storage management part 130.

In a case where the processor 161 has determined in step 2002 that the authentication information acquired in step 2001 is not legitimate authentication information, authentication fails. Accordingly, the processor 161 ends the storage management process without executing the subsequent steps.

On the other hand, in a case where the processor 161 has determined in step 2002 that the authentication information acquired in step 2001 is legitimate authentication information, authentication succeeds. Accordingly, the processor 161 acquires the status information from the disk generation request received by the storage management part 130 (2003).

Next, the processor 161 determines whether or not the status information acquired in step 2003 designates a storage apparatus 150 to be locked (2004).

In a case where the processor 161 has determined in step 2004 that the status information acquired in step 2003 does not designate a storage apparatus 150 to be locked, the processor 161 ends the storage management process without executing the subsequent steps, as the disk generation request received by the storage management part 130 is not a legitimate disk generation request.

On the other hand, in a case where the processor 161 has determined in step 2004 that the status information acquired in step 2003 designates a storage apparatus 150 to be locked, the processor 161 updates the nickname management table 131 on the basis of the disk generation request received by the storage management part 130, as the disk generation request is a legitimate disk generation request (2005).

Step 2005 is specifically described here.

First, the processor 161 adds a new entry to the nickname management table 131. Then, the processor 161 enters, in the nickname 1201 of the new entry, the nickname contained in the disk generation request, enters, in the server identifier 1202, the identifier of the physical server 140 as contained in the disk generation request, and enters, in the I/O device identifier 1203, the allocation destination I/O device identifier contained in the disk generation request.

It should be noted here that in order to manage the storage apparatus 150, the storage management part 130 retains the same table as the storage management table 122 retained by the server management part 110. This table has the same configuration as that of the storage management table 122 shown in FIG. 8, and is referred to as “storage management table”.

The processor 161 selects, from among those management I/F addresses entered in the management I/F address 801 of the storage management table, an entry that matches the management I/F address contained in the disk generation request. Then, the processor 161 acquires the identifier of a storage apparatus 150 as entered in the storage apparatus identifier 801 of the entry thus selected and the protocol entered in the protocol 802.

Then, the processor 161 enters, in the protocol 1204 of the new entry in the nickname management table 131, the protocol thus acquired, and enters, in the storage apparatus identifier 1205 of the new entry in the nickname management table 131, the identifier of the storage apparatus 150 as acquired.

Further, the processor 161 enters, in the disk number 1206 of the new entry in the nickname management table 131, the identifier of the logical volume to be allocated.

This causes the nickname management table 131 to be updated in step 2005, and enables the storage management part 130 to manage the identifier of the physical server 140 to which the logical volume 154 is allocated and the identifier of an I/O device of the allocation destination, although the identifiers are inputted only to the server management part 110. This makes it unnecessary for the administrator of the server management part 110 and the administrator of the storage management part 130 to share these items of information at a memo level.

Next, on the basis of the status information acquired in step 2003, the processor 161 notifies the storage apparatus 150 serving as a processing object of the address of the disk interface 164 of the storage management part 130 and configures the storage apparatus 150 serving as a processing object not to receive a command other than the address of the disk interface, thereby locking the storage apparatus 150 (2006).

Next, the processor 161 makes the logical volume 154 in the storage apparatus 150 serving as a processing object accessible from the allocation destination I/O device of the physical server 140 as contained in the disk generation request, thereby allocating the logical volume 154 to the physical server 140 (2007).

Next, the processor 161 unlocks the storage apparatus 150 configured in step 2006 (2008), and ends the storage management process.

A reason why the storage apparatus 150 is prohibited from processing other commands in the process of allocating the logical volume 154 to the physical server 140 in step 2007 is to prevent the storage apparatus 150 from being operated by another administrator to be incorrectly configured.

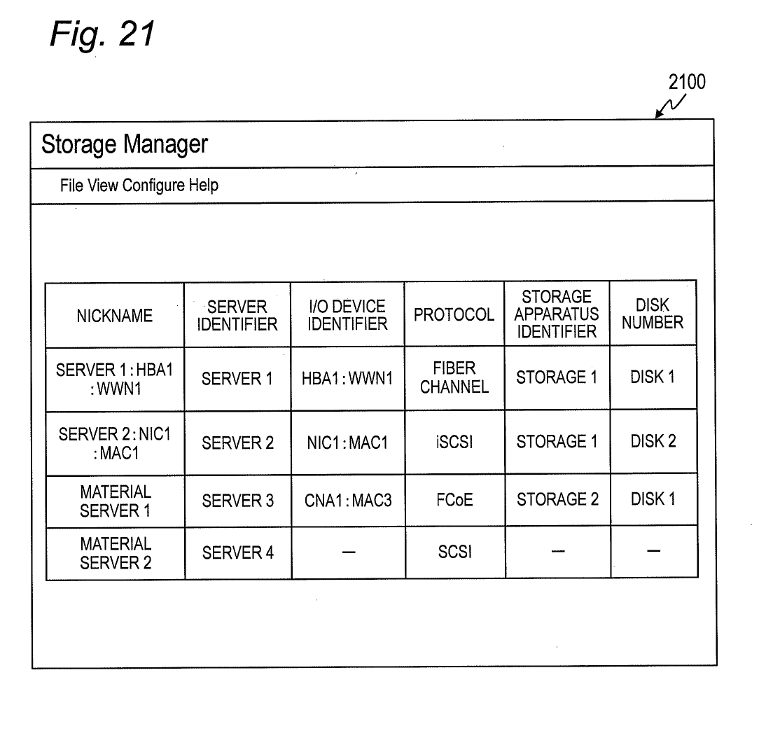

FIG. 21 is an explanatory diagram of a storage management screen 2100 according to the first embodiment of the present invention.

Upon receiving a request to display the storage management screen 2100, the storage management part 130 displays the storage management screen 2100 on a display or the like of a client. PC or the like.

The storage management screen 2100 serves to display the contents of the nickname management table 131. This allows the administrator to confirm the nickname management table 131 so that the administrator can confirm which logical volume 154 in which storage apparatus 150 is allocated to which I/O device of which physical server 140. This allows sharing of the information concerning the physical server 140 as managed by the server management part 110 and the information concerning the storage apparatus 150 as managed by the storage management part 130, thus making it unnecessary for the administrator of the server management part 110 and the administrator of the storage management part 130 to share these items of information at a memo level.

In the first embodiment, a description has been given of a process in which a storage area having stored therein a program that boots a physical server 140 is allocated to a new physical server 140. However, this does not imply any limitation. For example, a normal storage area from and to which a physical server 140 reads and writes data may be allocated to a physical server 140. In this case, in the disk allocation control process shown in FIG. 16, it is not necessary to search the new physical server 140 for a bootable I/O device, but only necessary to search the new physical server 140 for an I/O device connected to a storage apparatus 150.

### Second Embodiment

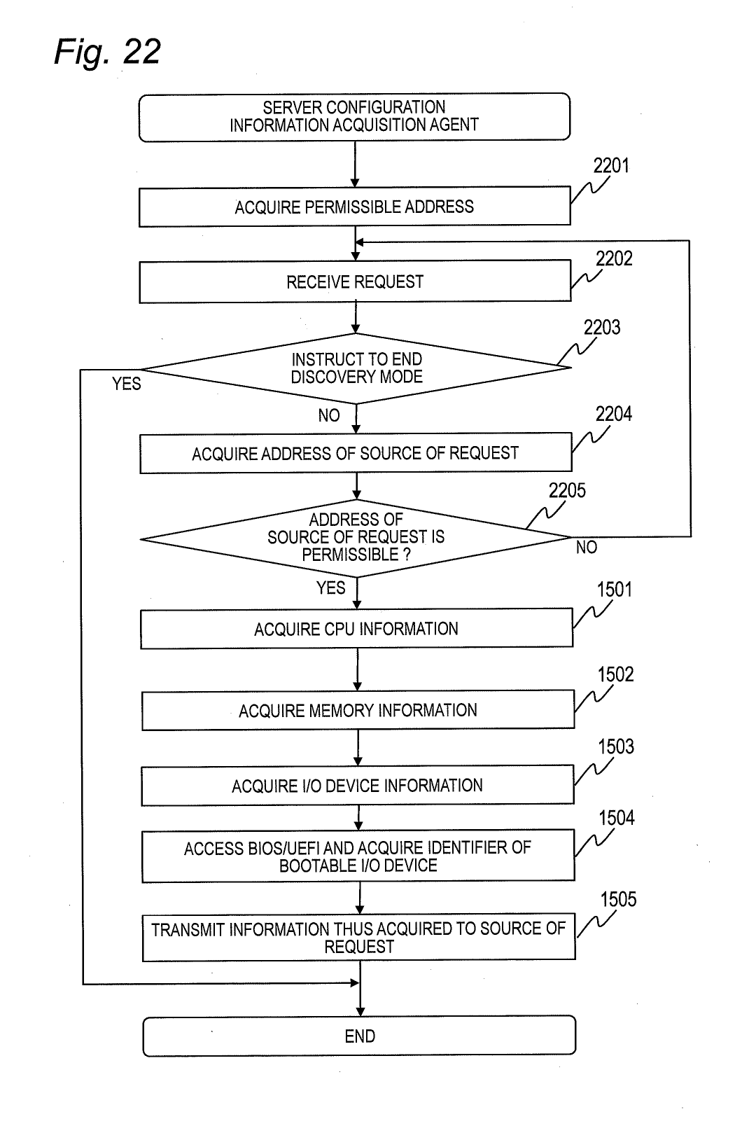

A second embodiment of the present invention is described below with reference to FIG. 22.

The present embodiment differs from the first embodiment in that a server configuration information acquisition agent has a discovery mode of transmitting the acquired configuration information of a physical server 140 in response solely to a request from a designated permissible address.

A server configuration information acquisition agent 115 of the first embodiment may undesirably transmit the acquired configuration information of a physical server 140 in response to a request from an address other than that of the server management part 110 that transmitted the server configuration information acquisition agent 115. In this case, the configuration information of the physical server 140 is undesirably transmitted to another computer. This poses a security problem.

In order to prevent such a problem, the present embodiment configures a server configuration information acquisition agent 115 so that the server configuration information acquisition agent transmits the acquired configuration information of a physical server 140 in response solely to a request from a designated address.

The present embodiment is described, for example, on the assumption that the address of the disk interface 164 that the storage management part 130 utilizes is a permissible address. It should be noted that the permissible address is not limited to the address of the disk interface.

In this case, in step 1304 shown in FIG. 13, the processor 161 acquires the address, entered in the management address 805 of the storage management table 121, of the disk interface 164 that the storage management part 130 utilizes, and invokes the server configuration information acquisition part 112, with the acquired address included in the permissible address.

Then, in step 1404 shown in FIG. 14, the processor 161 includes in the permissible address the address of the network interface 141 that the server management part 110 utilizes, and transmits the permissible address and the server configuration information acquisition agent 115 to the physical server 140.

Upon receiving the permissible address and the server configuration information acquisition agent 115, the physical server 140 executes a process, shown in FIG. 22, which is executed by the server configuration information acquisition agent 115.

FIG. 22 is a flow chart of a process that is executed by a server configuration information acquisition agent 115 according to an embodiment of the present invention. Those ones of the steps shown in FIG. 22 which are identical to those shown in FIG. 15 are given the same reference numerals, and as such, are not described here.

First, the processor 143 of a physical server 140 having received a server configuration information acquisition agent 115 acquires the permissible address by receiving the permissible address (2201).

Next, the processor 143 receives a server configuration information acquisition request (2202), and determines whether or not an instruction to end the discovery mode is contained in the server configuration information acquisition request thus received (2203). The discovery mode of the server configuration information acquisition agent 115 can be ended by input from the administrator of the server management part 110, and in a case where an instruction to end the discovery mode has been inputted to the server management part 110, the server management part 110 transmits the instruction to end the discovery mode as the server configuration information acquisition request to the physical server 140.

In a case where the processor 143 has determined in step 2202 that an instruction to end the discovery mode is contained in the server configuration information acquisition request, the processor 143 ends the process of the server configuration information acquisition agent 115.

On the other hand, in a case where the processor 143 has determined in step 2202 that an instruction to end the discovery mode is not contained in the server configuration information acquisition request, the processor 143 acquires the address of the source of the request thus received (2204).

Next, the processor 143 determines whether or not the address of the source as acquired in step 2204 is a permissible address (2205).

In a case where the processor 143 has determined in step 2205 that the address of the source as acquired in step 2204 is a permissible address, the processor 143 executes steps 1501 through 1505, transmits the configuration information of the physical server 140 to the source of the request, and ends the process that is executed by the server configuration information acquisition agent 115.

On the other hand, in a case where the processor 143 has determined in step 2205 that the address of the source as acquired in step 2204 is not a permissible address, the processor 143 returns to step 2202 without executing steps 1501 through 1505, as the request is from an address to which the processor 143 is prohibited from transmitting the configuration information.

This causes the server configuration information acquisition agent 115 to acquire the configuration information of the physical server 140 in response solely to a request from an address designated by a permissible address and transmit the configuration information to the source of the request, thus improving security.

### Third Embodiment

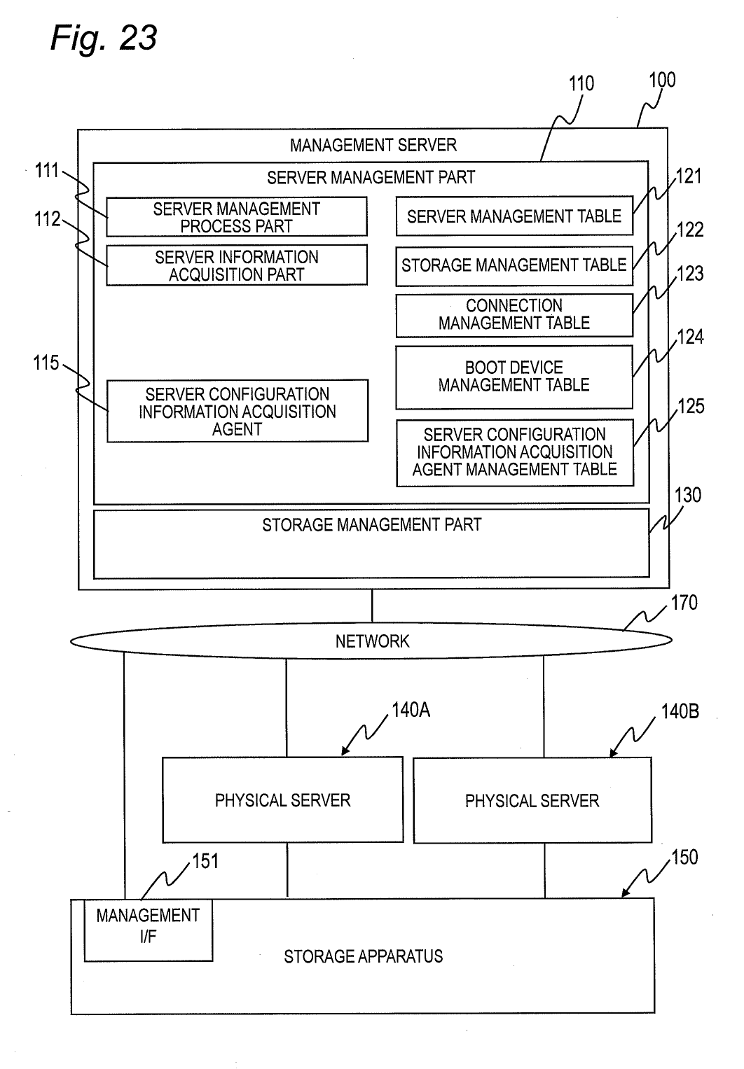

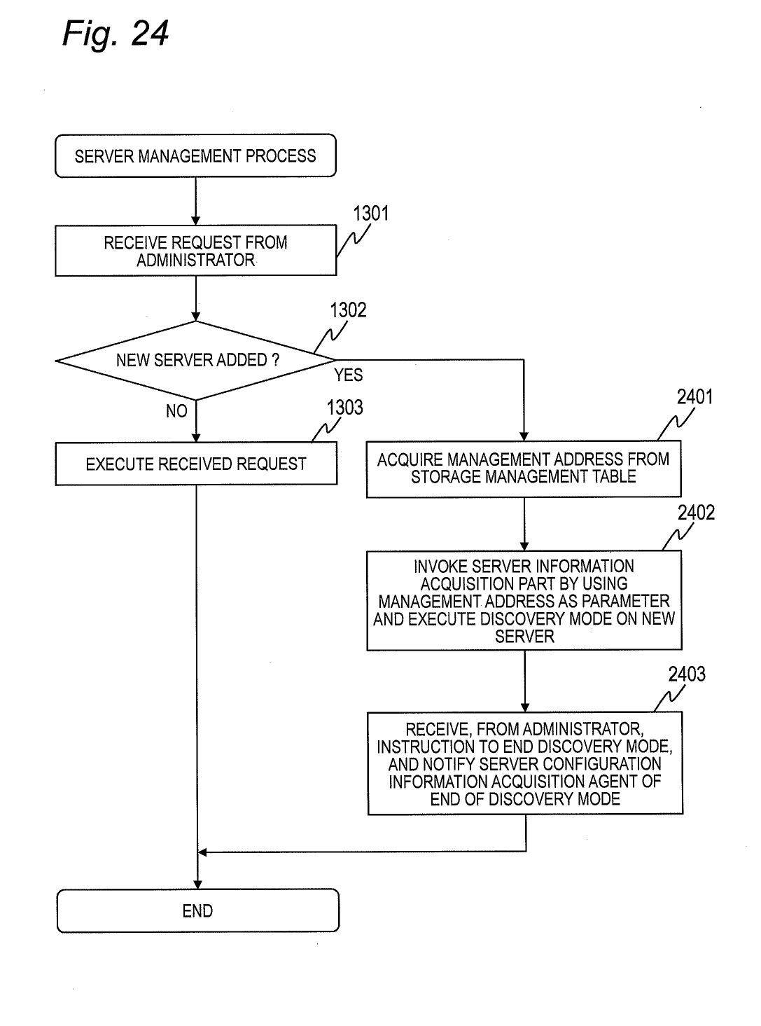

A third embodiment of the present invention is described below with reference to FIGS. 23 and 24.

The present embodiment describes an environment in which a server configuration information acquisition agent 115 for which a permissible address including the address of a disk interface 145 utilized by the storage management part 130 of the second embodiment is designated is useful.

FIG. 23 is an explanatory diagram of a configuration of a computer system according to the third embodiment of the present invention. Those ones of the components of the computer system shown in FIG. 23 which are identical to those of the computer system shown in FIG. 1 are given the same reference numerals, and as such, are not described here.

In a case where the producer of the program corresponding to the server management part 110 and the producer of the program corresponding to the storage management part 130 are different, cooperation between the server management part 110 and the storage management part 130 may not be achieved by the server management part 110 notifying the storage management part 130 of information concerning a physical server 140 as in the first embodiment.

For this reason, the server management part 110 shown in FIG. 23 does not include a disk allocation control part 113, a storage management cooperation part 114, or a disk protocol selection part 116. Further, the storage management part 130 shown in FIG. 23 does not include a nickname management table 131.

In a case where a new physical server 140 has been added in such an environment in which the server management part 110 and the storage management part 130 cannot exchange data with each other, the storage management part 130 cannot detect the addition of the new physical server 140 until an OS is installed on the new physical server 140, and therefore cannot allocate a logical volume 154 to the new physical server 140 before an OS is installed on the new physical server 140.

By utilizing a server configuration information acquisition agent 115 having a discover mode described in the second embodiment, the present embodiment configures the storage management part 130 to be able to detect the addition of a new physical server 140 before an OS is installed on the new physical server 140.

Specifically, the server management process part 111 invokes the server information acquisition part 112 by using as an parameter the address of the disk interface 164 that the storage management part 130 utilizes. Then, the server information acquisition part 112 includes the address of the disk interface 164 in a permissible address, and transmits the server configuration information acquisition agent 115 to the physical server 140. Further, since the server management part 110 and the storage management part 130 cannot exchange data with each other, a server management process that is executed by the server management process part 111 is different from the server management process that is executed by the server management process part 111 of the first embodiment, and as such, is described with reference to FIG. 24.

FIG. 24 is a flow chart of the server management process according to the third embodiment of the present invention. Those ones of the steps shown in FIG. 24 which are identical to those of the server management process of the first embodiment shown in shown in FIG. 13 are given the same reference numerals as those of FIG. 13, and as such, are not described here.

In a case where the processor 161 has determined in step 1302 that the request from the administrator is a request to add a new physical server 140, the processor 161 refers to the storage management table 122 and acquires the management address of a storage apparatus 150 connected to the new physical server 140 (2401).

Specifically, the processor 161 acquires, from the connection management table 123, the identifier of a storage apparatus 150 as entered in the connected apparatus 903 of an entry whose server identifier 901 matches the identifier of the new physical server 140. Then, the processor 161 selects, from among those entries in the storage management table 122, an entry in which the identifier of a storage apparatus 150 as entered in the storage apparatus identifier 801 matches the identifier of the storage apparatus 150 as acquired. Then, the processor 161 acquires an address entered in the management address 805 of the entry thus selected.

Next, the processor 161 invokes the program corresponding to the server information acquisition part 112 by using as an parameter the management address acquired in step 2402 (2402). When the processor 161 executes the program corresponding to the server information acquisition part 112, the server information acquisition process shown in FIG. 14 is executed. In the server information acquisition process shown in FIG. 14 of the present embodiment, in a case where the processor 161 transmits the server configuration information acquisition agent 115 to the new physical server 140 in step 1404, the processor 161 transmits the permissible address including the management address serving as the parameter and the server configuration information acquisition agent 115 to the new physical server 140.

In a case where the new physical server 140 has received the server configuration information acquisition agent 115, the processor 143 of the new physical server 140 executes the same process as the process, shown in FIG. 22, which is executed by the server configuration information acquisition agent 115 of the second embodiment.

Let it be assumed here that the storage management part 130 periodically transmits a request to acquire configuration information to a physical server 140 connected thereto. For this reason, as shown in FIG. 22, a physical server 140 having received a server configuration information acquisition agent 115 acquires configuration information in response to a request from the storage management part 130 and transmits the configuration information thus acquired to the storage management part 130. This makes it possible for the storage management part 130 to acquire the configuration information of the physical server 140 before an OS is installed on the physical server 140.

Now back to FIG. 24, upon receiving from the administrator an instruction to end the discovery mode, the processor 161 transmits the instruction to end the discovery mode to the physical server 140 that transmitted the server configuration information acquisition agent 115 (2403), and ends the server management process. As described in FIG. 22, when the physical server 140 receives the instruction to end the discovery mode, the processor 143 ends the process that is executed by the server configuration information acquisition agent 115.

This enables the storage management part 130 to acquire the configuration information of a physical server 140 before an OS is installed on the physical server 140. This enables the storage management part 130 to detect the addition of a new physical server 140. This makes it possible to allocate a boot device to a physical server 140 on which an OS has not been installed.

The present invention has been described in detail above with reference to the accompanying drawings. However, the present invention is to be limited to such specific configurations, but encompasses various modifications and equivalent configurations, provided such modifications and configurations fall within the spirit of the scope of the accompanying claims.

### INDUSTRIAL APPLICABILITY

The present invention is applicable to a computer system including a management computer in which management software for a physical server and management software for a storage apparatus are separate.

What is claimed is:

1. A computer system comprising:
at least one computer having at least one input-output interface that is connectable to at least one external device;
at least one storage apparatus having at least one storage area that is allocatable to the at least one computer coupled thereto via the at least one input-output interface; and
a management computer having a computer management part that manages the at least one computer and a storage management part that manages the at least one storage apparatus, the management computer holding connection management information for managing at least one relationship of connection between the at least one computer and the at least one storage apparatus,
the computer management part including:
a configuration information acquisition part that acquires configuration information including an identifier of a new computer and at least one identifier of the at least one input-output interface of the new computer, in a case where the new computer is added to the computer system;
an allocation control part that, based on the configuration information acquired by the configuration information acquisition part and the connection management information, outputs as at least one allocation candidate, the at least one input-output interface connected to the at least one storage apparatus among the at least one input-output interface of the new computer, and that receives at least one input-output interface selected by a user among the at least one outputted allocation candidate; and
a storage management cooperation part that notifies the storage management part of the identifier of the new computer and at least one identifier of the at least one input-output interface received by the allocation control part, and that invokes the storage management part,
the storage management part is configured to;
hold the identifier of the new computer and the at least one of the identifier of the at least one of input-output interface of which the storage management part is notified,
allocate the at least one storage area to the new computer, by making it possible to access, from the at least one input-output interface identified by the at least one identifier of the at least one of the input-output interface of which the storage management part is notified, the at least one storage area of the at least one storage apparatus connected to the at least one input-output interface.

2. A computer system according to claim 1, wherein:
the computer holds in advance at least one identifier of at least one input-output interface connected to a storage area in which at least one program capable of booting the at least one computer is stored;
the configuration information, which the configuration information acquisition part acquires from the new computer, includes the at least one identifier of the at least one input-output interface connected to the storage area in which the program capable of booting the new computer is stored; and
the allocation control part outputs, as the at least one allocation candidate, at least one input-output interface connected to the at least one storage apparatus and capable of the booting.

3. A computer system according to claim 1, wherein:
the storage management cooperation part includes a name generation part that, based on the identifier of the new computer acquired by the configuration information acquisition part and the at least one identifier of the at least one input-output interface received by the allocation control part, generates a name by which the new computer is able to be identified;
the storage management cooperation part notifies the storage management part of the identifier of the new computer, the at least one identifier of the at least one input-output interface received by the allocation control part, and the name generated by the name generation part; and
the storage management part stores therein the identifier of the new computer, the at least one identifier of the at least one input-output interface, and the name.

4. A computer system according to claim 1, wherein:
the management computer holds at least one configuration information acquisition agent corresponding to at least one type of at least one OS installed on the at least one computer;
the configuration information acquisition part identifies a type of an OS installed on the new computer and transmits to the new computer a configuration information acquisition agent corresponding to the identified type of the OS;
upon receiving the configuration information acquisition agent, the new computer acquires the configuration information by executing the received configuration information acquisition agent, and transmits the acquired configuration information to the management computer; and
the configuration information acquisition part acquires the configuration information by receiving the configuration information transmitted from the new computer.

5. A computer system according to claim 4, wherein:
the configuration information acquisition part transmits a permissible address and the configuration information acquisition agent to the new computer, the permissible address being an address that permits the configuration information to be acquired;
in a case where the new computer receives an acquiring request of the configuration information after executing the received configuration information acquisition agent, and an address of a source of the received acquiring request matches the permissible address, the new computer acquires the configuration information, and transmits the acquired configuration information to the source of the acquiring request.

6. A computer system according to claim 1, wherein while executing a process for making it possible for the new computer to access the at least one storage area, the storage management part prohibits a process from being executed in response to another request.

7. A program-cooperative method for cooperating a computer management program and a storage management program to cooperate in a computer system including:
at least one computer having at least one input-output interface that is connectable to at least one external device;
at least one storage apparatus having at least one storage area that is allocatable to the at least one computer connected thereto via the at least one input-output interface; and
a management computer executing the computer management program to manage the at least one computer, and the storage management program to manage the at least one storage apparatus, the management computer holds connection management information for managing at least one relationship of connection between the at least one computer and the at least one storage apparatus,
the method including:
a configuration information acquisition step in which the computer management program acquires configuration information including an identifier of the a new computer and at least one identifier of the at least one input-output interface of the new computer;
an allocation control step in which, based on the configuration information acquired by the configuration information acquisition part and the connection management information, the computer management program outputs as at least one allocation candidate, the at least one input-output interface connected to the at least one storage apparatus among the at least one input-output interface of the new computer, and receives the at least one input-output interface selected by a user among the outputted allocation candidate;
a storage management cooperation step in which the computer management program notifies the storage management program of the identifier of the new computer and at least one identifier of at least one input-output interface selected in the allocation control step, and invokes the storage management program; and
a step in which the storage management program, invoked in the storage management cooperation step, holds the identifier of the new computer and the at least one identifier of the at least one input-output interface of which the storage management part is notified and, allocates the at least one storage area to the new computer, by making it possible to access, from the at least one input-output interface identified by the at least one identifier of the input-output interface of which the storage management program is notified, the at least one storage area of at least one storage apparatus connected to the input-output interface.

8. A program-cooperative method according to claim 7, wherein:
the computer holds in advance at least one identifier of at least one input-output interface connected to at least one storage area in which a program capable of booting the computer is stored;
the configuration information, which is acquired from the new computer in the configuration information acquisition step, includes the at least one identifier of the at least one input-output interface connected to the at least one storage area in which the program capable of booting the new computer is stored; and
in the allocation control step, the computer management program outputs, as the at least one allocation candidate, the at least one input-output interface connected to the at least one storage apparatus and capable of the booting.

9. A program-cooperative method according to claim 7, wherein:
the storage management cooperation step includes a name generation step in which, based on the identifier of the new computer acquired in the configuration information acquisition step and the at least one identifier of the at least one input-output interface selected in the allocation control step, the computer management program generates a name by which the new computer is able to be identified;
in the storage management cooperation step, the computer management program notifies the storage management program of the identifier of the new computer, the at least one identifier of the at least one input-output interface selected in the allocation control step, and the name generated in the name generation step; and
in the storage management step, the storage management program holds the identifier of the new computer, the at least one identifier of the at least one input-output interface, and the name.

10. A program-cooperative method according to claim 7, wherein:
the management computer holds a configuration information acquisition agent corresponding to at least one type of at least one OS installed on the at least one computer; and
the configuration information acquisition step includes:
a step in which the computer management program identifies a type of an OS installed on the new computer;
a step in which the computer management program transmits to the new computer a configuration information acquisition agent corresponding to the identified type of the OS thus identified; and
a step in which upon receiving the configuration information acquisition agent, the new computer acquires the configuration information by executing the received configuration information acquisition agent, and transmits the configuration information acquired to the management computer.

11. A program-cooperative method according to claim 10, wherein:
the configuration information acquisition step includes:
a step in which the computer management program transmits a permissible address and the configuration information acquisition agent to the new computer, the permissible address being an address that permits the configuration information to be acquired; and
a step in which, in a case where the new computer receives a request to acquire the configuration information after executing the received configuration information acquisition agent, and an source address of the received request matches the permissible address, the new computer acquires the configuration information, and transmits the acquired configuration information to the source of the request.

12. A program-cooperative method according to claim 7, wherein in the storage management step, while executing a process for making it possible for the new computer to access the at least one storage area, the storage management program prohibits a process from being executed in response to another request.

13. A program for causing a processor to execute a process in a management computer having the processor, the management computer managing at least one computer having at least one input-output interface that is connectable to at least one external device and at least one storage apparatus having at least one storage area that is allocatable to the at least one computer connected thereto via the at least one input-output interface, the process being a process for managing the at least one computer,
the process comprising:
a configuration information acquisition step of acquiring configuration information containing an identifier of a new computer and at least one identifier of the at least one input-output interface of the new computer, in a case where the new computer is added to a computer system;
an allocation control step of, based on the configuration information acquired in the configuration information acquisition step and the connection management information, outputting, as at least one allocation candidate, the at least one input-output interface connected to the at least one storage apparatus among the at least one input-output interface of the new computer, and receiving the at least one input-output interface selected by a user among the outputted allocation candidates; and
a storage management cooperation step of notifying a program for managing the at least one storage apparatus of the identifier of the new computer and at least one identifier of at least one input-output interface selected in the allocation control step.

14. A program according to claim 13, wherein:
the computer holds in advance at least one identifier of at least one input-output interface connected to at least one storage area in which a program capable of booting the computer is stored;
the configuration information, which is acquired from the new computer in the configuration information acquisition step, includes the at least one identifier of the at least one input-output interface connected to the at least one storage area in which the program capable of booting the new computer is stored; and
in the allocation control step, the at least one input-output interface connected to the at least one storage apparatus and capable of the booting are outputted as the at least one allocation candidate.

15. A program according to claim 13, wherein:
the storage management cooperation step includes a name generation step of, based on the identifier of the new computer acquired in the configuration information acquisition step and the at least one identifier of the at least one input-output interface selected in the allocation control step, generating a name by which the new computer is able to be identified; and
the program for managing the at least one storage apparatus is notified of the identifier of the new computer, the at least one identifier of the at least one input-output interface selected in the allocation control step, and the name generated in the name generation step.

16. A program according to claim 13, wherein:
the management computer holds at least one configuration information acquisition agent corresponding to at least one type of at least one OS installed on the at least one computer; and
the configuration information acquisition step includes:
a step of identifying a type of an OS installed on the new computer; and
a step of causing the new computer to execute the configuration information acquisition agent corresponding to the identified type of the OS and, in order to acquire the configuration information, transmitting the configuration information acquisition agent to the new computer.
